(19) United States
(12) Patent Application Publication
(10) Pub. No.: US 2026/0219470 A1
(43) Pub. Date: Jul. 30, 2026

(54) FIBER OPTIC PULLING ASSEMBLY WITH BREAKOUT

(71) Applicant: CommScope Technologies LLC, Claremont, NC (US)

(72) Inventors: Cyle D. PETERSEN, Belle Plaine, MN (US); Kenneth Allen SKLUZACEK, Belle Plaine, MN (US); Jonathan R. KAML, Shakopee, MN (US); Paula LOCKHART, New Prague, MN (US); David R. WURST, Minneapolis, MN (US); Scott L. CARLSON, Bloomington, MN (US)

(73) Assignee: CommScope Technologies LLC, Claremont, NC (US)

(21) Appl. No.: 19/124,187

(22) PCT Filed: Oct. 30, 2023
(86) PCT No.: PCT/US2023/078238

§ 371 Date: Apr. 24, 2025

Related U.S. Application Data
(60) Provisional application No. 63/420,569, filed on Oct. 29, 2022.
(60) Provisional application No. 63/463,244, filed on May 1, 2023.
(60) Provisional application No. 63/593,871, filed on Oct. 27, 2023.

(51) Int. Cl. G02B 6/54

(52) U.S. Cl. CPC G02B 6/54

(57) ABSTRACT

A cable pulling assembly includes a cable pulling arrangement over a cable assembly. The cable assembly includes a cable breakout with a multi-part housing positioned over a transition portion of a main cable and a plurality of subunits. The breakout includes circular or cylindrical portions and an inspection aperture. During assembly, at least a portion of the cable breakout is rotatable relative to the main cable and the plurality of subunits. The subunits may be spliced on, with a protective assembly with a conduit over multiple axially spaced encapsulated splice locations that splice multifiber ribbons, and at least one non-encapsulated region within the conduit between the encapsulated splice locations where the non-encapsulated region is more flexible than the encapsulated splice locations.

### CROSS-REFERENCE TO RELATED APPLICATIONS

This application is being filed on Oct. 30, 2023, as a PCT International Application and claims the benefit of U.S. Provisional Application No. 63/420,569, filed Oct. 29, 2022; U.S. Provisional Application No. 63/463,244, filed May 1, 2023; and U.S. Provisional Application No. 63/593,871, filed Oct. 27, 2023, the disclosures of which are hereby incorporated by reference in their entireties.

### BACKGROUND

Optical fiber cable assemblies include a main cable portion including a plurality of cable subunits. The main cable portion includes a jacket that surrounds first portions of the cable subunits. Second portions of the cable subunits extend past an end of the main cable portion. In certain implementations, a fanout or breakout transitions the cable subunits from the main cable portion. Some example breakouts are shown in U.S. Pat No. 11,480,751, 11,131,821, 11,372,188, 11,131,822, 8,705,930, US2021/0124140, US20210302657, US20220291453, and WO2023/069602.

Optical fiber cable assemblies are installed within central offices or datacenters by pulling the optical fiber cable assemblies through conduits routed through the buildings. Typically, the conduits have narrow diameters (e.g., 4 inches, 3 inches, 2 inches, 1.25 inches, etc.). Accordingly, the optical fiber cable assemblies are packaged to fit through the conduits. When preterminated with optical connectors, the amount of room to pull these cable assemblies through the conduits becomes tight. However, the optical fiber cable assemblies must be pulled through the conduits without damage to the fibers or to the connectors.

Improvements are desired.

### SUMMARY

Aspects of the present disclosure are directed to a cable pulling assembling including a cable pulling arrangement for use in pulling a cable assembly. The cable assembly includes a cable breakout that transitions from a main cable portion to cable subunits. The cable breakout includes a multi-part housing.

In one implementation, a portion of the cable breakout is rotatably mounted to the main cable at some point during manufacture of the cable assembly.

In certain implementations, cable subunits can include connectorized ends. Groups of connectors at the connectorized ends can be separately bundled into a bag or a short sleeve. The bag or short sleeve maintains the connectors of each group together during pulling of the cable assembly.

In certain implementations, a crush resistant layer is provided over the cable assembly.

In certain implementations, the crush resistant layer is mounted over a plastic sleeve that extends over a portion of the cable. In certain examples, the plastic sleeve provides water resistance to the portion of the cable. In certain examples, the portion of the cable includes portions of cable sub-units extending beyond a jacketed main portion of the cable assembly.

In certain implementations, a mesh sleeve can be disposed over the crush resistant layer. The mesh sleeve is secured at both axial ends. A first axial end of the mesh sleeve is secured to the main portion of the cable assembly or to a breakout of the cable assembly to provide sufficient strength to pull the cable by the mesh sleeve. A second axial end of the mesh sleeve is secured closed (e.g., to form a pulling loop).

A conduit is provided, and multiple encapsulated splice locations are axially spaced within the conduit. At least one non-encapsulated region is positioned within the conduit between the encapsulated splice locations. The non-encapsulated region is more flexible than the encapsulated splice locations. In certain implementations, the conduit is part of a cable assembly with spliced on connectors.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic depiction of a cable assembly including multiple cable sub-units extending outwardly from a main cable portion;

FIG. 2 shows an example implementation of connectorized ends of one or more cable sub-units of the cable assembly of FIG. 1;

FIG. 3 shows an example implementation of the connectorized ends of the cable sub-units bundled in separate bags;

FIG. 4 is a schematic depiction of the bags bundling connector groups of the cable sub-units;

FIG. 5 is a schematic depiction of a plastic sleeve disposed over the cable sub-units of FIG. 4 including over the bundled connector groups;

FIG. 6 is a schematic depiction of multiple discrete tubing members disposed over the plastic sleeve of FIG. 5;

FIG. 7 shows an example implementation of the cable assembly of FIG. 6 with an example implementation of a mesh pulling sleeve laid alongside it;

FIG. 8 is a schematic depiction of the cable assembly of FIG. 6 with a mesh pulling sleeve mounted thereover;

FIG. 9 is a schematic view of an example partitioned bag suitable for use in managing the connectors of the cable sub-units;

FIG. 10 shows the connectors of an example cable sub-unit disposed within an example partitioned bag where one of the connectors terminates shorter optical fibers than the other connectors of the sub-unit;

FIG. 11 shows two partitioned bags staggered along the length of the cable assembly, each partitioned bag separately holding the connectors of one cable subunit of the cable assembly;

FIG. 12 shows a schematic view of the cable assembly including a main cable breakout, and two subunit cable breakouts.

FIG. 13 is a top perspective view of an example main cable breakout.

FIG. 14 is an exploded view of the main cable breakout of FIG. 13.

FIG. 15 is a bottom perspective view of the top member of the main cable breakout of FIGS. 13 and 14.

FIG. 16 is a further top perspective view of the bottom member of the main cable breakout of FIGS. 13 and 14.

FIG. 17 is an end view of the organizer member of the main cable breakout of FIGS. 13 and 14.

FIG. 18 is an exploded perspective view of the organizer member of FIG. 17.

FIG. 19 shows alternative organizer members and insert members for the main cable breakout of FIGS. 13 and 14.

FIG. 20 shows further alternative organizer members and insert members for the main cable breakout of FIGS. 13 and 14.

FIGS. 21-26 show various steps and intermediate assemblies occurring during assembly of the cable assembly in one example.

FIG. 27 shows an alternative cable assembly including mesh sleeves covering the cable subunits.

FIG. 28 shows an alternative insert member to the insert members shown in FIGS. 13, 14, and 17-20.

FIGS. 29-65 show alternative main cable breakouts including a molded main body extending over the transition from the main cable to the cable subunits, a molded main body extending between an insert member and an organizer member.

FIGS. 29 and 30 show two side views of a first alternative cable breakout including a molded main body, an organizer, and an insert with 144 fibers.

FIGS. 31 and 32 show two side views of a second alternative cable breakout including a molded main body, an organizer, and an insert with 432 fibers.

FIGS. 33 and 34 show two side views of a third alternative cable breakout including a molded main body, an organizer, and an insert with 2880 fibers.

FIG. 35 shows the cable breakout of FIGS. 33 and 34 and a separate heat shrink tubing.

FIG. 36 shows heat shrink tubing in place over cable breakout of FIG. 35.

FIG. 37 shows the cable breakout of FIG. 36 with the heat shrink tubing in the final shape, and a second cable without a heat shrink in place.

FIG. 38 shows an enlarged view of the cable breakout of FIG. 37 with the heat shrink in place.

FIGS. 39 and 40 show a mold for forming the cable breakout of FIGS. 29 and 30.

FIGS. 41 and 42 show a mold for forming the cable breakout of FIGS. 31 and 32.

FIGS. 43 and 44 show a mold for forming the cable breakout of FIGS. 33 and 34.

FIGS. 45-47 show the molds of FIGS. 39-44 with the respective cables in place.

FIGS. 48-50 show the molds and cables of FIGS. 45-47 with the top mold portion removed after the molding process.

FIGS. 51-55 show various steps in the molding process for molding the cable breakout of FIGS. 31 and 32.

FIGS. 56 and 57 show a mold and molding steps for molding the cable breakout of FIGS. 33 and 34.

FIGS. 58-61 show an alternative mold and an alternative cable breakout, including an additional molding fill hole.

FIGS. 62-65 show a further alternative mold and an alternative cable breakout, including an additional molding fill hole, and a cable with 3456 fibers.

FIGS. 66 and 67 show a cable assembly with spliced on connectors.

FIGS. 68-71 show the splice protection assembly of the cable assembly of FIGS. 66 and 67. FIG. 69 is a cross-section of FIG. 68. FIG. 70 shows the flexible region before the spiral wrap is added. FIG. 71 shows the assembly before the outer mesh, the heat shrinks, the fanout overmold, and the rear overmold are added.

FIG. 72 shows an initial view of the cable assembly of FIGS. 66 and 67, during assembly.

FIGS. 73-93 show further views of the cable assembly of FIGS. 66 and 67, during assembly.

FIGS. 94-96 show the cable assembly of FIGS. 66 and 67 in a linear arrangement, a curved arrangement, and positioned within equipment in a curved arrangement.

FIG. 97 shows a prior art splice protection assembly.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

The present disclosure is directed to a pullable cable assembly, a pulling arrangement disposable around the cable assembly, and methods of manufacture thereof. The pulling arrangement is disposed around a cable assembly to enable the cable assembly to be pulled or otherwise routed along a conduit. In certain implementations, the pulling arrangement also provides crush resistance or otherwise protects the cable assembly. In certain implementations, the pulling arrangement maintains the relative placement of the connectorized ends of the cable assembly.

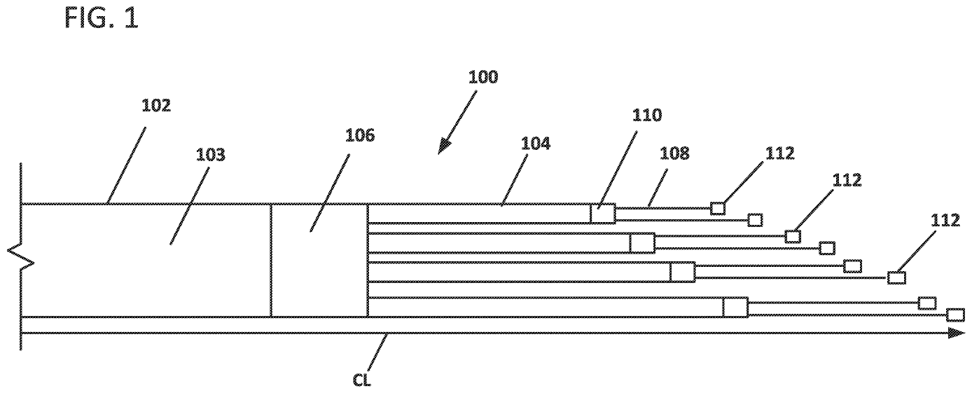

Referring to FIG. 1, a cable assembly 100 includes a main cable portion 102 including a plurality of cable subunits 104. The cable assembly 100 has an axial length CL extending between opposite ends of the cable assembly 100. The main cable portion 102 includes a jacket 103 that surrounds first portions of the cable subunits 104. Second portions of the cable subunits 104 extend past an end of the main cable portion 102. In certain implementations, a fanout or breakout 106 transitions the cable subunits 104 from the main cable portion 102.

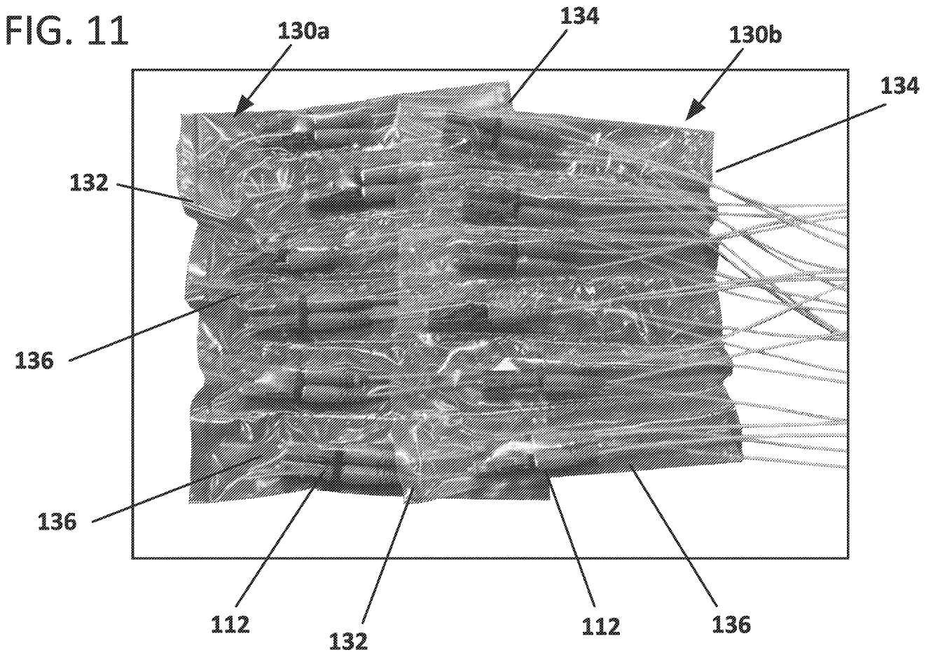

Each cable subunit 104 includes one or more optical fibers 108 that are terminated at optical connectors 112. In some implementations, each optical fiber 108 is separately connectorized at a single-fiber optical connector. In other implementations, multi-fiber optical connectors terminate multiple ones of the optical fibers 108. In certain implementations, the cable subunits 104 have different lengths, resulting in the optical connectors 112 being staggered along the length of the cable assembly 100. In certain examples, the optical fibers 108 are staggered in groups 113 (e.g., see FIGS. 3 and 11). In certain implementations, the optical fibers 108 of each group 113 transition from cable subunit 104 at another breakout or fanout 110 to smaller subunits.

As will be described below in more detail, and with reference to FIGS. 1-8, cable assembly 100 is covered by a pulling assembly 115 containing one or more layers, structures or members 118, 122, 124, to enable cable assembly 100 to be pulled or otherwise routed along a conduit or other pathway structure.

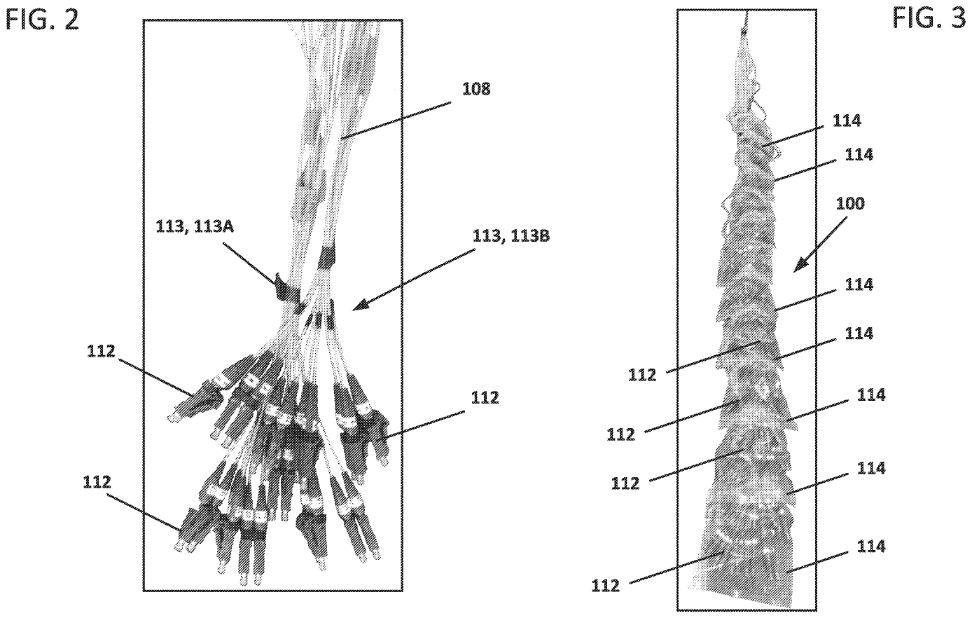

FIG. 2 illustrates two example groups 113A, 113B of optical fibers 108. The fibers 108 of the first group 113A are longer than the fibers 108 of the second group 113B so that the optical connectors 112 terminating the fibers 108 of the first group 113A are offset from the optical connectors 112 terminating the fibers 108 of the second group 113B. In certain implementations, the optical fibers 108 of each group 113 transition from a cable subunit 104 at another breakout or fanout 110. In certain implementations, the optical fibers 108 of each group 113 are taped together.

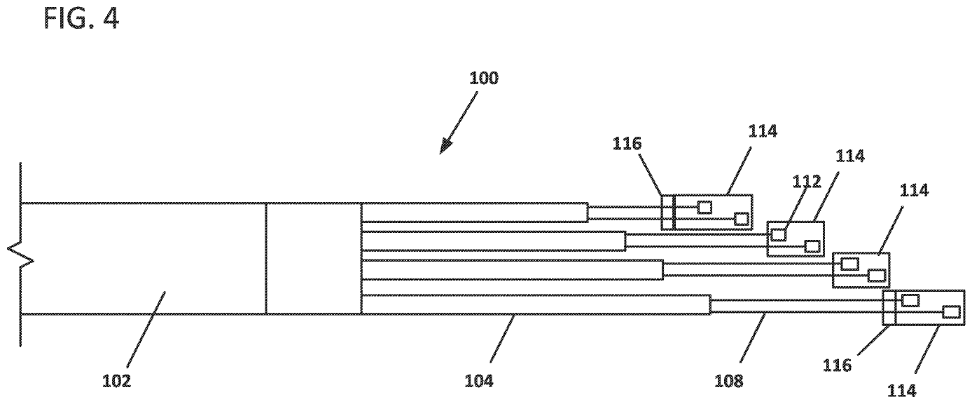

As shown in FIGS. 3 and 4, each group 113 of connectors 112 can be separately bundled into a bag 114 or short sleeve. The bag 114 or short sleeve maintains the connectors 112 of each group 113 together during pulling of the cable assembly 100. The bag 114 of short sleeve also facilitates identification of each connector group 113 during installation of the cable assembly 100. In certain implementations, the bag 114 or short sleeve is formed of plastic. In certain examples, the bag 114 or short sleeve is translucent. In certain implementations, the bag 114 or short sleeve is secured around each group 113 using tape 116, a cable tie, a hook-and-loop strap, or other securement mechanism.

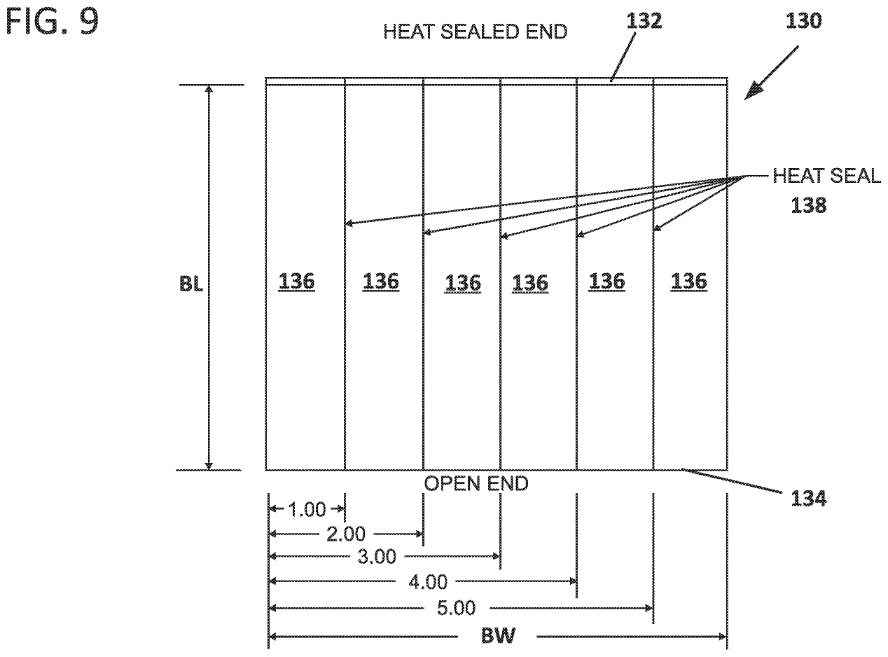

FIGS. 9-11 illustrate an alternative implementation of the bag 130 suitable for bundling the connectors 112 of a group 113. The bag 130 extends along a length BL from a closed end 132 to an open end 134 and along a width BW between opposite closed ends. The open end 134 provides access to an interior of the bag 130. The interior of the bag 130 is partitioned into separate chambers 136 that each extend along the length BL between the closed end 132 and the open end 134 of the bag 130. In certain examples, the chambers 136 are divided by heat seals 138. In some examples, each chamber 136 is fully sealed from the other chambers 136. In other examples, the heat seals 138 are interrupted along the length BL of the bag 130. In certain implementations, each chamber 136 is sized to receive a respective one of the connectors 112 of the group 113. Accordingly, the relative positions of the connectors 112 with respect to each other are maintained, thereby facilitating management of the optical fibers extending from the connectors 112.

In certain implementations, the chambers 136 of a bag 130 have a common size. In certain examples, the chambers 136 have widths sufficient to accommodate only one connector 112 (e.g., a simplex connector, a duplex connector, a multi-fiber connector, etc.) per chamber 136. In certain examples, each chamber 136 has a width of about 1 inch. In other examples, each chamber 136 can have a larger or smaller width (e.g., 0.5 inches, 1.5 inches, 2 inches, etc.). In certain implementations, the length BL of the bag 130 is defined to be larger than a length of any of the connectors 112. Accordingly, the bag 130 is sized to accommodate rework (e.g., resplicing of the optical fibers).

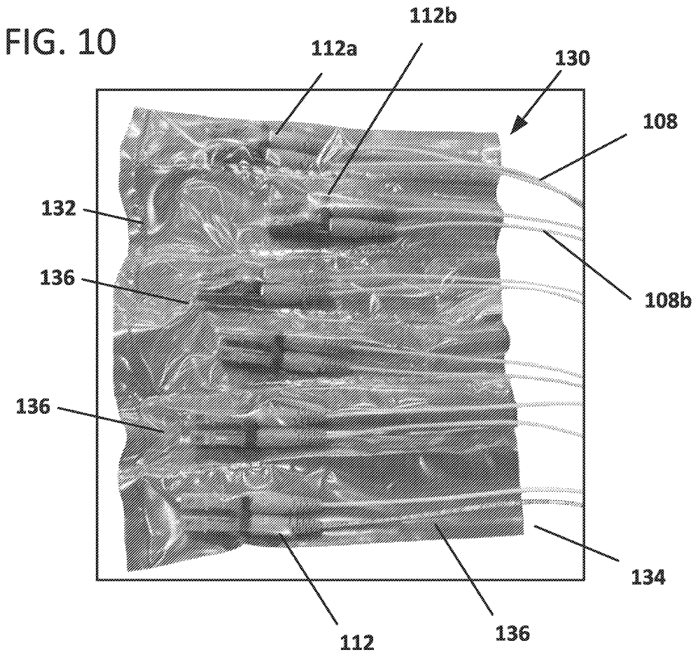

The connectors 112 can be positioned at any point along the length BL of the respective chambers 136. In the example shown in FIG. 10, the second connector 112b is disposed closer to the open end 134 of the bag 130 than the other connectors 112 (e.g., closer than the first connector 112a) because the second connector 112b was respliced to the second fibers 108b. The respective chamber 136 is sufficiently long to fully contain all of the connectors 112. In certain examples, the length BL of the bag 130 is at least double the length of one of the connectors 112. In certain examples, the length BL of the bag 130 is at least three times the length of one of the connectors 112. In certain examples, the length BL of the bag 130 is no more than three times the length of the one of the connectors 112. In certain examples, the length LB of the bag 130 is at least 5 inches.

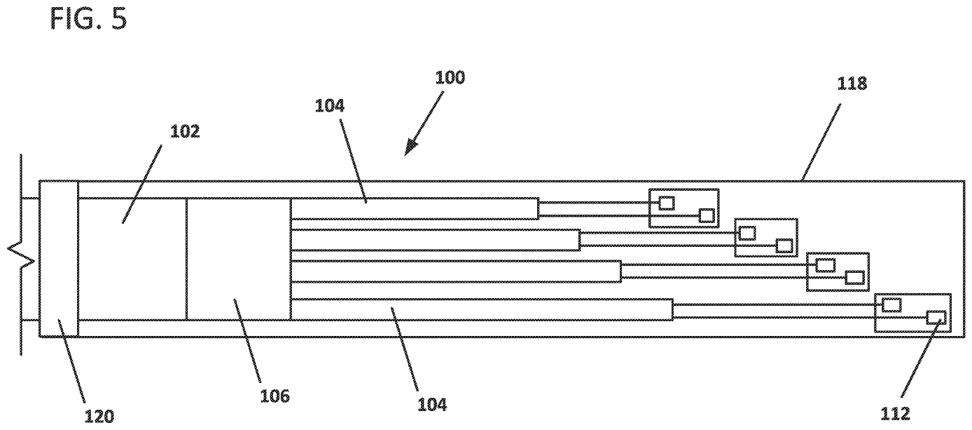

Referring now to FIG. 5, a sleeve 118 is pulled over the bundled groups 113 of connectors 112. In certain implementations, the sleeve 118 is pre-mounted on the main cable portion 102 before the connectors 112 are bundled in groups 113 and the sleeve 118 is slid over the bundled groups 113 from the main cable portion 102. In certain implementations, the sleeve 118 is formed of plastic. In certain examples, the sleeve 118 is translucent. In certain examples, the sleeve 118 extends fully over the second portions of the cable subunits 104. In certain examples, the sleeve 118 extends over the breakout 106.

In certain examples, the sleeve 118 is secured to the main cable portion 102 of the cable assembly 100 using tape 120, a cable tie, a hook-and-loop strap, or other securement mechanism. For example, the sleeve 118 may be secured to the jacket 103 of the main cable portion 102. In certain examples, the sleeve 118 is configured to provide water resistance to protect the optical connectors 112 and/or the optical fibers 108. In certain examples, the sleeve 118 has an internal diameter sized to fit sufficiently tightly over the cable subunits 104 to inhibit relative movement therebetween without radially compressing the connectors 112. In certain examples, a distal end of the sleeve 118 may be folded, crumpled, or otherwise closed. In certain examples, the distal end of the sleeve 118 may be held closed with tape, a clip, or another securement mechanism.

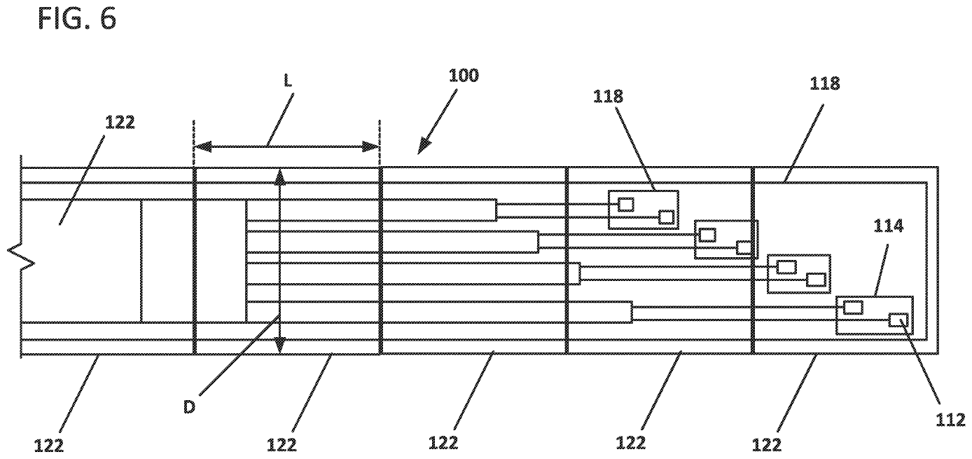

As shown in FIG. 6, crush resistance is provided by installing multiple tubing members 122 over the sleeve 118. Crushing forces can occur by radially directed compressive forces exerted by a mesh sleeve over the cables and the connectors 112, as will be described below. In certain implementations, the tubing members 122 are disposed end-to-end to extend along the axial length L of the cable assembly 100. The tubing members 122 may contact each other but are not directly coupled to each other. In certain implementations, each tubing member 122 is sized to fit over a bundled group 113 of connectors 112. In certain implementations, each tubing member 122 is sized to fit over the breakouts 106, 110.

In certain implementations, the tubing members 122 have smooth outer circumferential walls. In certain implementations, the tubing members 122 have smooth inner circumferential walls. In certain implementations, each tubing member 122 has a constant inner diameter along the axial length L of the tubing member 122. In certain implementations, each tubing member 122 has a constant outer diameter along the axial length L of the tubing member 122. In certain implementations, the tubing members 122 have corrugated circumferential walls.

In some implementations, the tubing members 122 can be pre-mounted on the main cable portion 102 before terminating the cable subunits 104. In such implementations, the tubing members 122 can be slid over the sleeve 118 from the main cable portion 102. In other implementations, the tubing member 122 are slid over the sleeve 118 from the distal end of the cable subunits covered by bags 114 towards the main cable portion 102. In certain implementations, the tubing members 122 are formed of plastic. In some implementations, the tubing members 122 are formed of butyrate. Other implementations are possible. Corrugated tubing in unsegmented form or helix wire tubing in unsegmented form may be used instead of the segmented tubular pieces.

In certain implementations, each tubing member 122 has an outer diameter D that is no more than 3 inches. In certain examples, each tubing member 122 has an outer diameter D that is no more than 2 inches. In certain examples, each tubing member 122 has an outer diameter D that is no more than 1.9 inches. In certain examples, each tubing member 122 has an outer diameter D that is no more than 1.8 inches. In certain examples, each tubing member 122 has an outer diameter D that is no more than 1.7 inches. In certain examples, each tubing member 122 has an outer diameter D that is no more than 1.25 inches. In certain examples, each tubing member 122 has an outer diameter D that is no more than 1.2 inches. In certain examples, each tubing member 122 has an outer diameter D that is no more than 1.1 inches.

In some examples, the tubing members 122 have a common axial length L. In other examples, the tubing members 122 may have different axial lengths L. In certain implementations, the tubing members 122 are each sized to have an axial length L between 1 inch and 10 inches long. In certain examples, the tubing members 122 are each sized to have an axial length L between 2 inches and 8 inches long. In certain examples, the tubing members 122 are each sized to have an axial length L between 1 inch and 6 inches long. In certain examples, each tubing member 122 is sized to have an axial length L between 2 inches and 4 inches long.

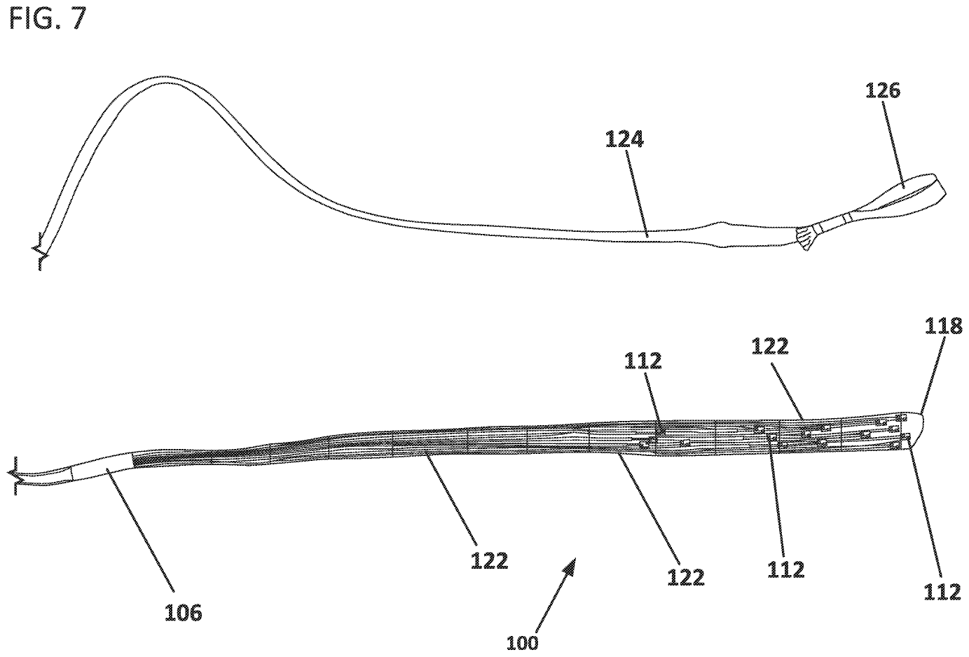

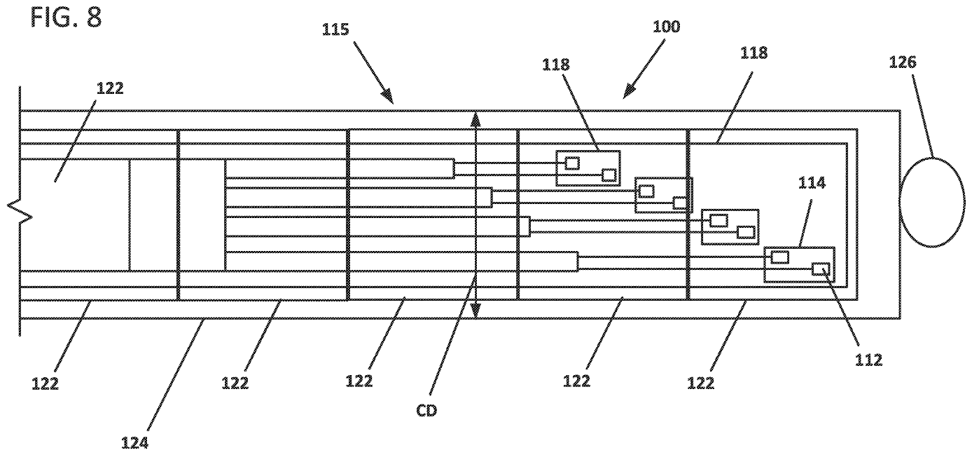

Referring to FIGS. 7 and 8, a mesh sleeve 124 is installed over the cable assembly 100 so that the tubing members 122 are disposed within the mesh sleeve 124. In some implementations, the mesh sleeve 124 is pre-installed over the main cable portion 102 before bundling the connector groups 113. In other implementations, the mesh sleeve 124 is slid over the cable assembly 100 and tubing members 122 from the distal end of the cable subunits 104.

In certain implementations, a first axial end of the mesh sleeve 124 is secured to the main cable portion 102. For example, the first end of the mesh sleeve 124 may be secured by tape, a cable tie, a hook-and-loop strap, or other securement mechanism. In certain implementations, the first end of the mesh sleeve 124 is secured to the breakout 106 of the cable assembly 100. The mesh sleeve 124 has a second axial end 126 that is looped (e.g., see FIG. 7) or otherwise configured to enable attachment of a pulling cable or other pulling mechanism.

In certain implementations, the mesh sleeve 124 is configured to radially constrict when pulled axially. In certain implementations, the mesh sleeve 124 has a resting inner diameter (i.e., an inner diameter when no axial tension is applied to the mesh sleeve 124) of no less than 1.1 inches. In certain examples, the mesh sleeve 124 has a resting inner diameter of no less than 1.2 inches. In certain examples, the mesh sleeve 124 has a resting inner diameter of no less than 1.5 inches. In certain examples, the mesh sleeve 124 has a resting inner diameter of no less than 1.6 inches. In certain examples, the mesh sleeve 124 has a resting inner diameter of no less than 1.7 inches. In certain examples, the mesh sleeve 124 has a resting inner diameter of no less than 1.8 inches. In certain examples, the mesh sleeve 124 has a resting inner diameter of no less than 1.9 inches. In certain examples, the mesh sleeve 124 has a resting inner diameter of no less than 2 inches.

In certain implementations, the tubing members 122 can withstand a radial compressive force of the mesh sleeve 124 when a tensile load of at least 100 pounds is applied to the mesh sleeve 124. In certain implementations, the tubing members 122 can withstand a radial compressive force of the mesh sleeve 124 when a tensile load of at least 200 pounds applied to the mesh sleeve 124. In certain implementations, the tubing members 122 can withstand a radial compressive force of the mesh sleeve 124 when a tensile load of at least 300 pounds applied to the mesh sleeve 124. In certain implementations, the tubing members 122 can withstand a radial compressive force of the mesh sleeve 124 when a tensile load of at least 400 pounds applied to the mesh sleeve 124. In certain implementations, the tubing members 122 can withstand a radial compressive force of the mesh sleeve 124 when a tensile load of at least 500 pounds applied to the mesh sleeve 124. In certain implementations, the tubing members 122 can withstand a radial compressive force of the mesh sleeve 124 when a tensile load of at least 600 pounds applied to the mesh sleeve 124.

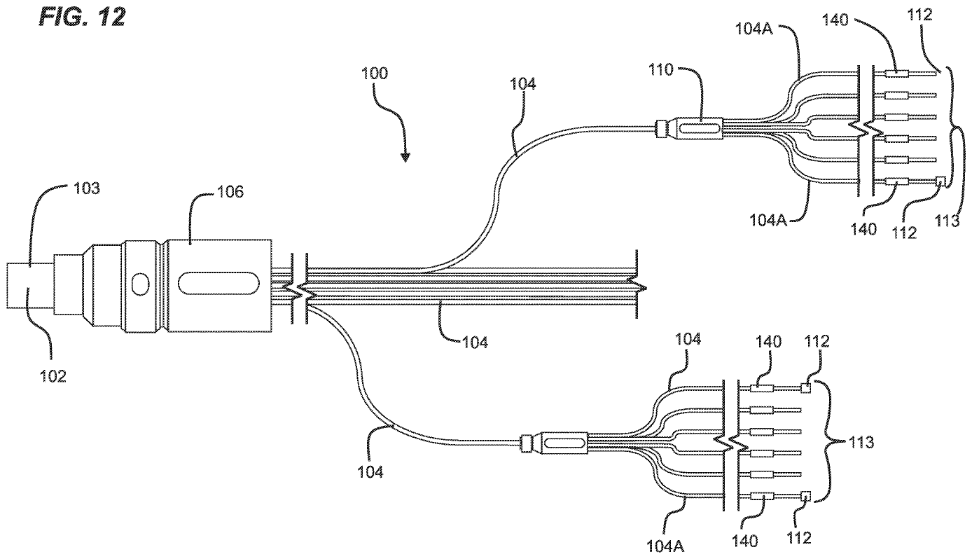

Referring now to FIG. 12, cable assembly 100 is shown in a further illustration. Main cable portion 102 includes the plurality of cable subunits 104. Breakout 106 transitions the cable subunits 104 from the main cable portion 102. Each cable subunit 104 includes one or more optical fibers 108 that are terminated at optical connectors 112. As noted above, each optical fiber 108 is separately connectorized at a single-fiber optical connector, or multi-fiber optical connectors terminate multiple ones of the optical fibers 108. The optical fibers 108 of each group 113 transition from cable subunit 104 at another breakout or fanout 110 to smaller subunits 104A. Each subunit 104A can be provided with a label 140 two differentiate each subunit 104A in each group 113. Each of the groups 113 can be placed in the bag 114 is described above. The pulling assembly 115 described above containing one or more layers, structures or members 118, 122, 124, is positioned over cable assembly 100 to enable cable assembly 100 to be pulled or otherwise routed along a conduit or other pathway structure.

Still referring to FIG. 12, breakout 106 transitions between main cable portion 102 and subunits 104. Breakouts 110 transition between subunits 104 and smaller subunits 104A. Both breakouts 106, 110 includes a fixation media, such as flowable epoxy, which cures or hardens around the cable structures entering and exiting each breakout.

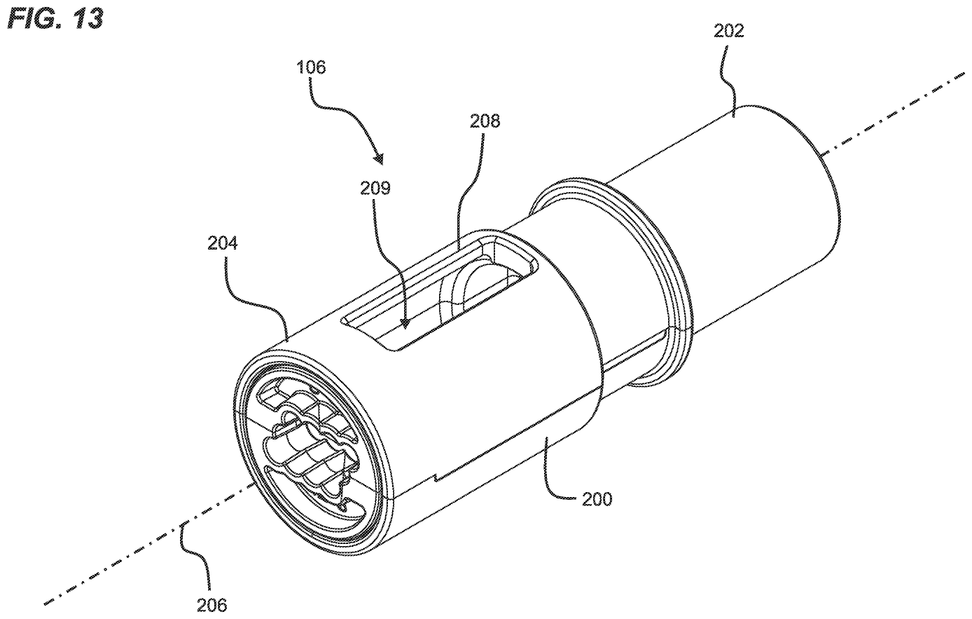

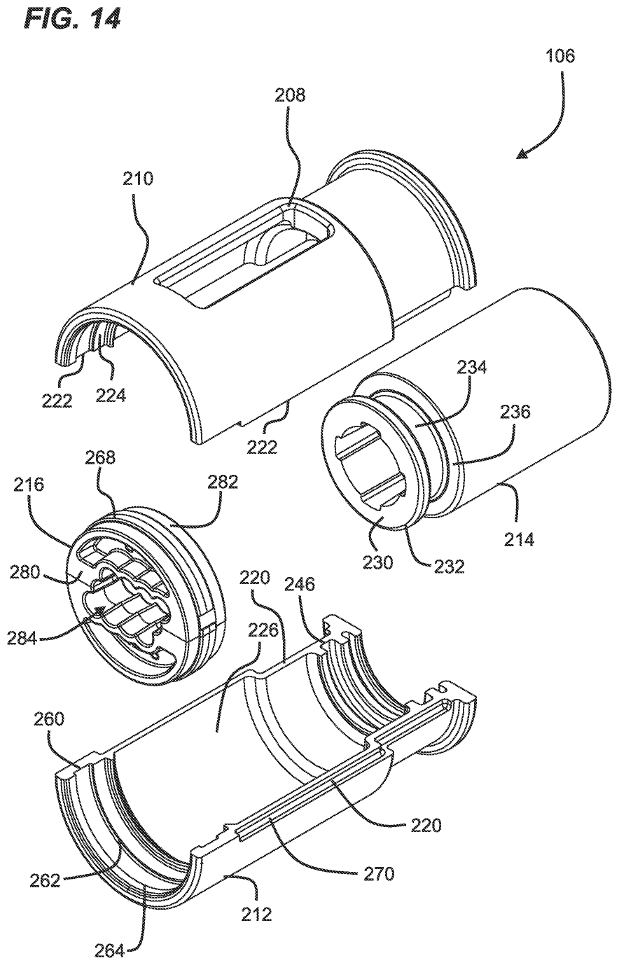

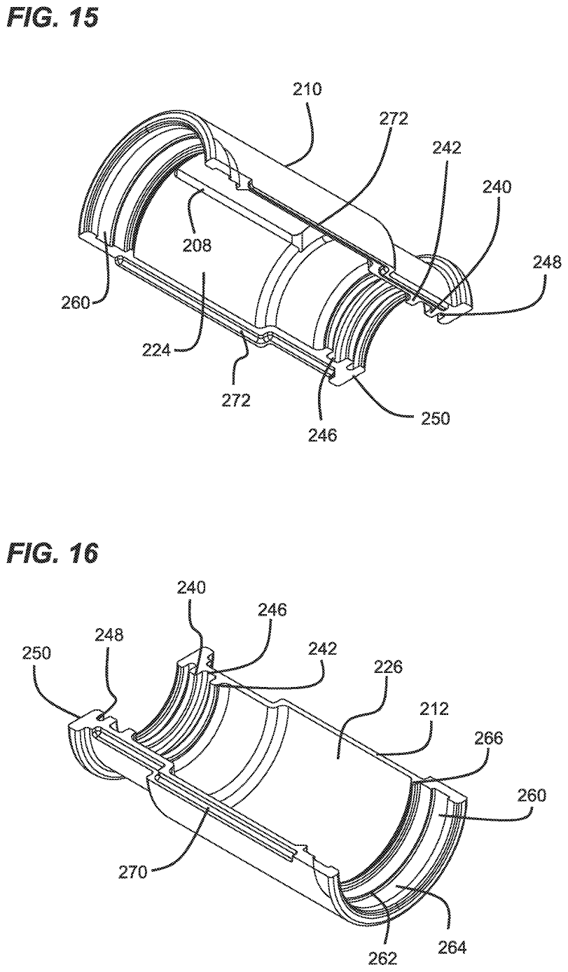

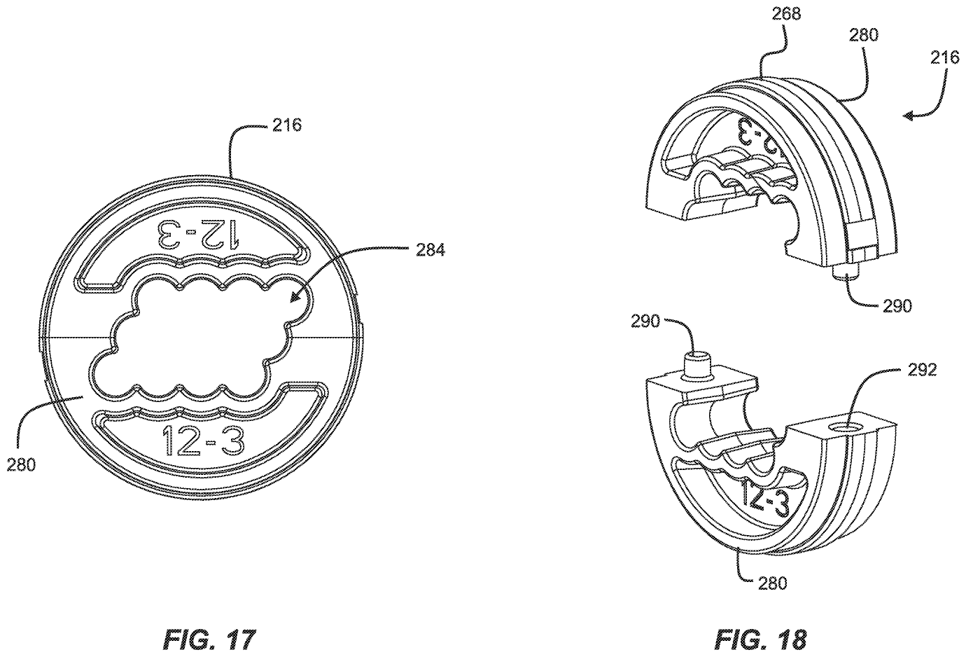

Referring now to FIGS. 13-18, one implementation of breakout 106 is shown. Breakout 106 includes a body 200 extending from an entry end 202, to an exit end 204. Body 200 enclosures the transition from the cable entering at end 202, in this case main cable portion 102, to the cable or cables exiting at end 204, in this case cable subunits 104. An inspection aperture 208 allows for visual access to the interior of the body 200. Inspection aperture 208 also allows for filling of body 200 with the flowable epoxy in interior 209 during manufacture.

Body 200 of breakout 106 includes a multi-part housing, including top member 210, a bottom number 212, an insert 214, and an endcap or organizer 216. Various portions of the multi-part housing include circular or cylindrical configurations relative to longitudinal axis 206. Insert 214 mounts over the end of main cable portion 102. In one implementation, insert 214 is held to jacket 103 of main cable portion 102 by a heat shrink. Top member 210 and bottom member 212 mounted to each other along edges 220, 222. A portion of interior surfaces 224, 226 mounts around an exterior end portion 230 of insert 214. Interior surfaces 224, 226 include two ribs 240, 242 and a groove 246 which mounts around rib 232 of insert 214. Interior surfaces 224, 226 includes a further groove 248, and an end surface 250. Insert 214 includes a groove 234 and a shoulder 236 248.

When insert 214 is secured to main cable portion 102, top member 210 and bottom member 212 are rotatable with respect to insert 214 before the epoxy is added to the interior of breakout 106.

At exit end 204 of breakout 106, organizer 216 is held by structure on interior surfaces 224, 226 of top member 210 and bottom member 212. Interior surfaces 224, 226 include a groove 260 with two shoulders 262, 264, interior surfaces 224, 226 include an additional shoulder 266. Rib 268 of organizer 216 is received in groove 260. Top member 210 and bottom member 212 are rotatable with respect to insert 214 before the epoxy is added to the interior of breakout 106.

Edges 220, 222 of top member 210 and bottom member 212 include interlocking arrangement in the form of notches 270 on bottom number 212, and ribs 272 on top number 210.

Organizer 216 has a front face 280 and a rear face 282, facing in opposite directions. Organizer 216 has at least one aperture 284 extending between the front face 280 and the rear face 282. In one implementation, organizer 216 is made from two identical halves 286. Each half 286 includes an interlocking arrangement to facilitate securement together. In one implementation the interlocking arrangement includes a post 290 and an aperture.

Aperture 284 of the organizer 216 receives the cable subunits 104. The subunits can be in the form of optical fibers, ribbon cables, with or without protective overtubing. The protective overtubing may include a polymeric tubing, which can include an outer tube, an inner tube and strength members in between, such as aramid yarns. The protective overtubing can also include a mesh sleeve instead of the polymeric tubing. During manufacture of cable assembly 100, the protective overtubings are slid over the optical fibers 108. Breakout 106 secures the ends the overtubing to body 200 of breakout 106. Fixed

Aperture 284 of organizer 216 can have a shape which is conducive to organizing the protective overtubings of the subunits. Aperture 284 can be sized for different sizes of overtubing and or different numbers of overtubings and subunits.

Organizer 216 is useful for helping to organize and secure the protective overtubings. Organizer also helps to contain the flowable fixation media, before it cures or hardens in place, from leaking out.

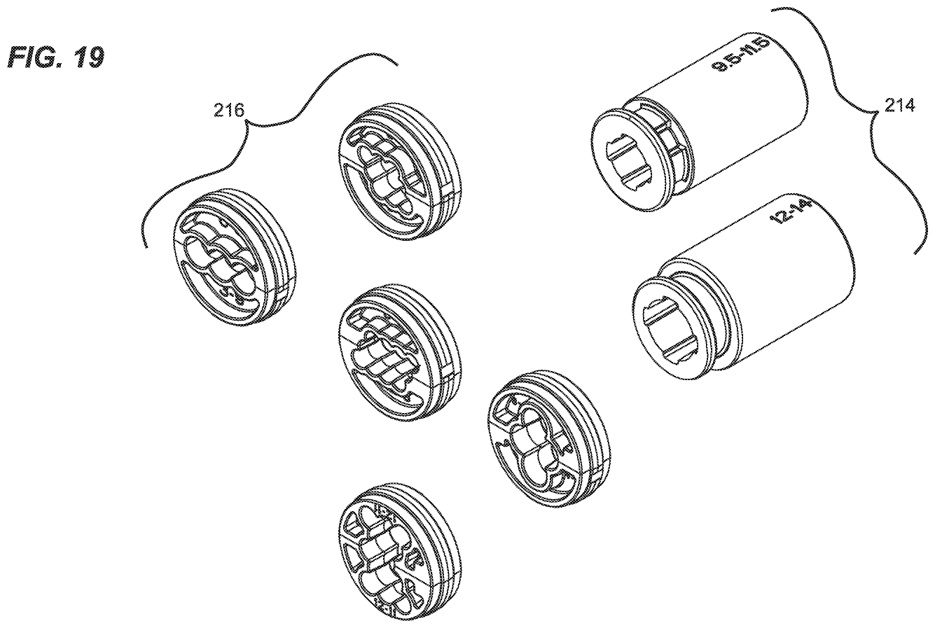

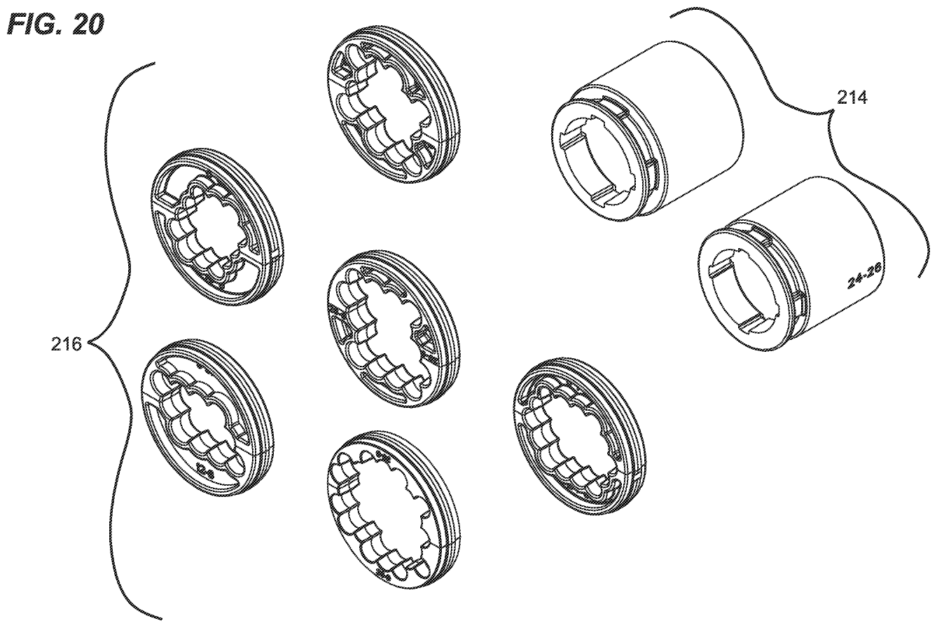

Referring now to FIGS. 19 and 20, different inserts 214 and different organizers 216 are shown. The different inserts are each usable with the same or similarly shaped top and bottom members 210, 212. The different inserts 214 are shown for use with different main cable portions 102 having different outside diameters. The different organizers 216 are shown to illustrate the different options that can be implemented for the numbers of outgoing subunits and/or the different sizes of the subunits that might be desired for the cable assembly 100.

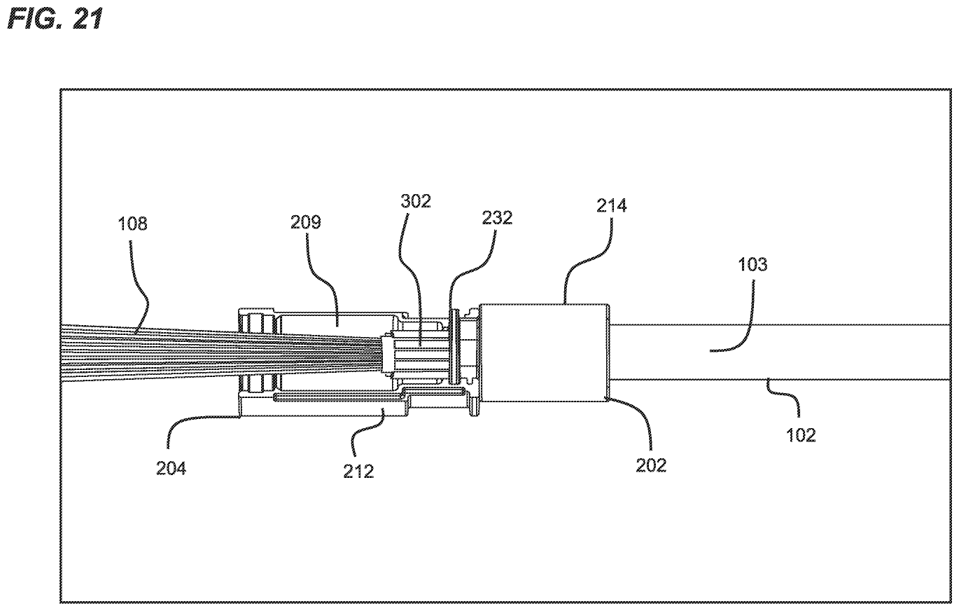

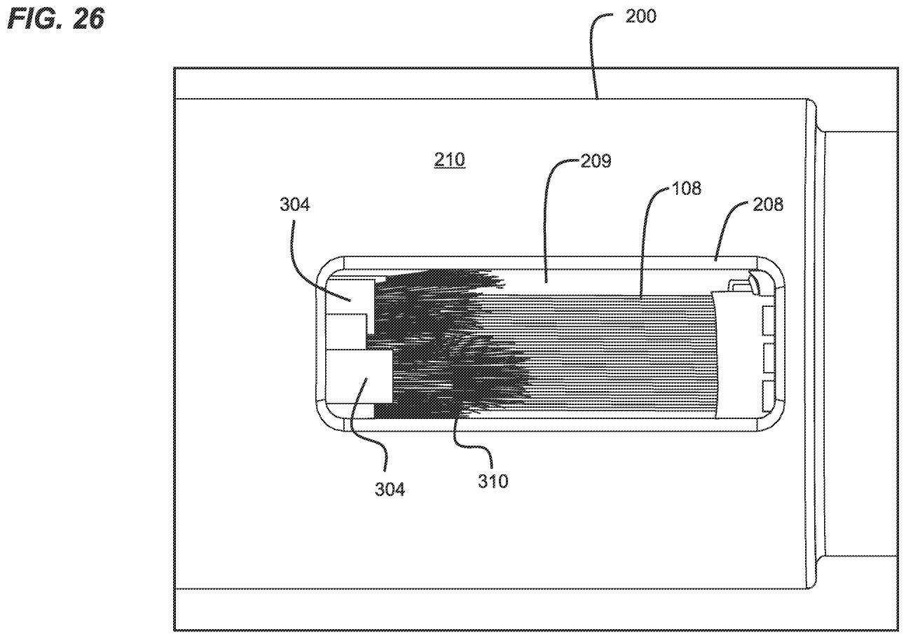

Referring now to FIGS. 21-27, further features of the cable breakout 106 and related methods of assembly are shown. In FIG. 21, insert 214 is shown mounted over the transition portion of main cable portion 102. Insert 214 is slid over the end of jacket 103. As shown, outer jacket 103 has been removed exposing the inner portions of main cable portion 102 including optical fibers 108. Also visible in FIG. 21 are the ends of additional structures 302 within main cable portion 102, end portions which have been cut away, to expose optical fibers 108. These additional structures can include inner tubes, strength members, and fiber organizers, such as fiber wrappings which wrap the fibers into discrete groupings.

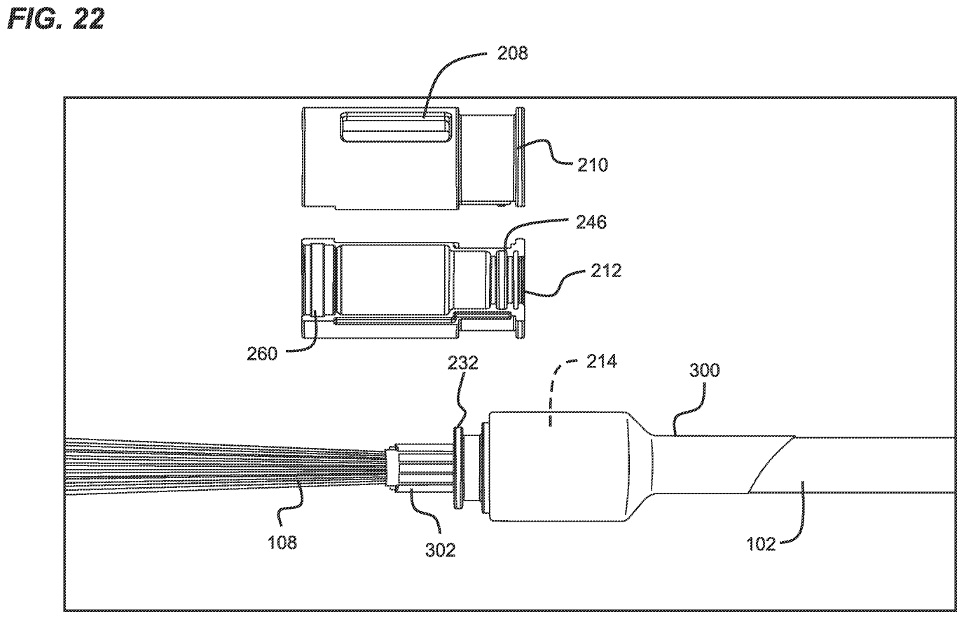

Referring now to FIG. 22, insert 214 is shown affixed to main cable portion 102 by a heat shrink 300.

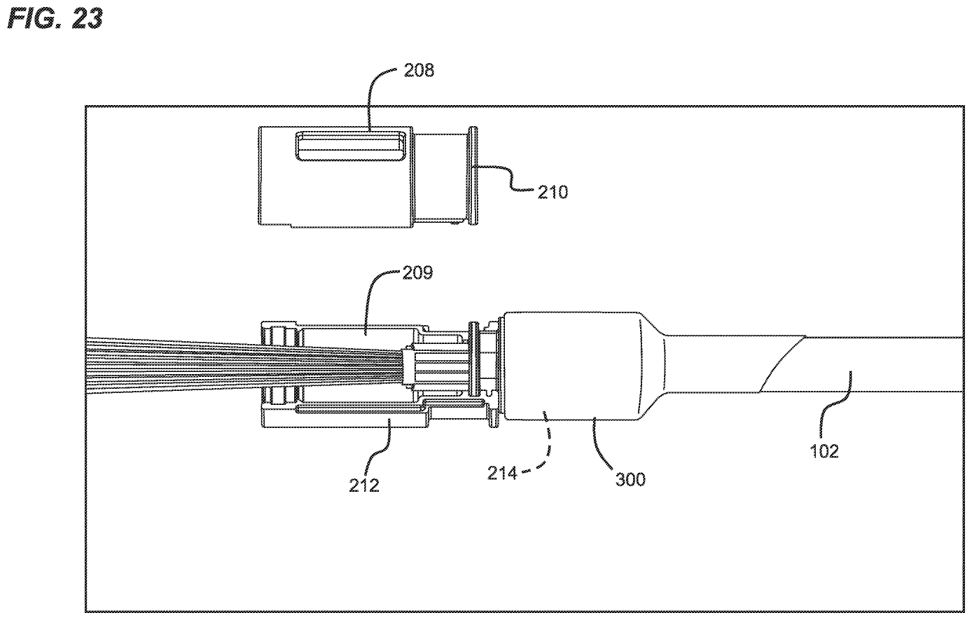

Referring now to FIG. 23, bottom member 212 is shown positioned about the rib 232 of insert 214. The manufacturing personnel have access to the interior to lay out the fibers is a desired arrangement.

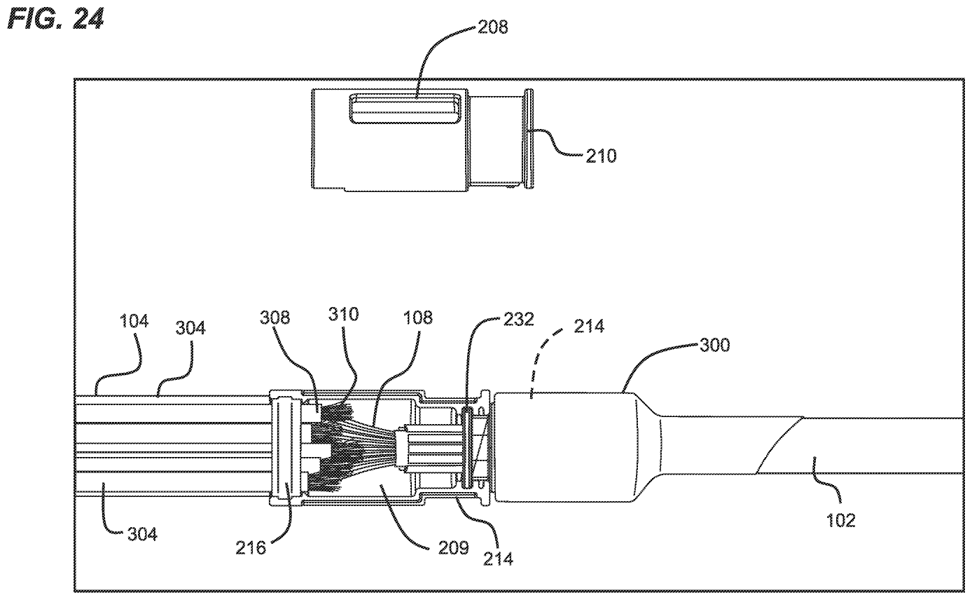

Referring now to FIG. 24, organizer 216 is assembled around the overtubings 304, with the two-part design. Organizer 216 organizes overtubings 304 which are positioned over optical fibers 108 as part of subunits 104. Positioned within interior 209 of body 200 or breakout 106 are the ends 308 of overtubings 304 including exposed portions of strength members 310. The manufacturing personnel have access to the interior to lay out the fibers and the ends of the overtubings is a desired arrangement.

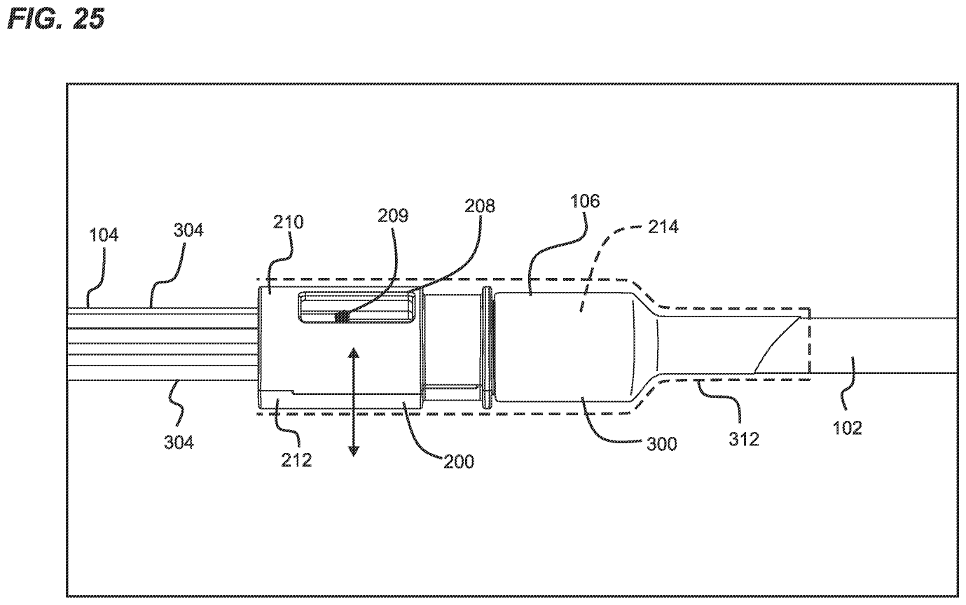

Referring now to FIG. 25, top member 210 is shown in position engaging rib 232 of insert 214, bottom member 212 and organizer 216. Inspection aperture 208 can be utilized by the manufacturing personnel to observe the transition portion of the main cable portion to the subunits. Once the manufacturing personnel are satisfied that the interior elements are in a proper position, epoxy can be placed in through inspection aperture 208 into interior 209 and allowed to cure and/or harden.

If inspection aperture 208 is not in a desired position relative to main cable portion 102 and subunits 104, top and bottom members 210, 212 can be rotated together to reposition inspection aperture 208. Such a situation may arise due to main cable portion 102 being a stiff cable and not easily rotated itself due to its length and or connection to other structures. By rotating the top and bottom numbers, the inspection aperture 208 can be properly positioned to view, and then for the flowable fixation media to be placed into interior 209. Tape can be used to hold top and bottom members 210, 212 in position. Once the flowable fixation media is allowed to cure or harden, a further heat shrink can be added over breakout 106, as shown in FIG. 25.

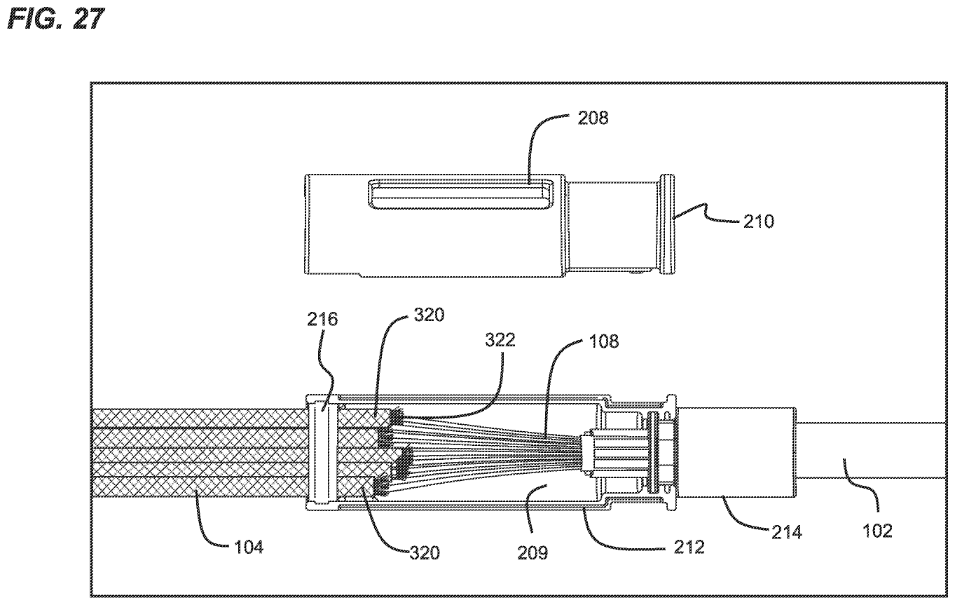

FIGS. 24-26 show the protective overtubings in the form of polymeric tubings including an outer tube, and inner tube and strength members positioned between the outer and inner tubes. FIG. 27 shows mesh sleeves 320 instead of overtubings 304. Mesh sleeves 320 tend to unravel or fray at ends 322. In a similar manner, breakout 106 fixes of affixes the mesh sleeves to the breakout with the flowable fixation media once it is cured and or hardened.

Referring now to FIG. 28, an alternative organizer 416 is shown as including two-sided foam tape. The main cable portion and the fibers are shown in this view. Like organizers 216 described above, organizer 416 holds the overtubings in position during assembly, and also prevents leakage of the flowable fixation media.

The circular or cylindrical configurations allow for relative rotation and/or multiple mounting positions of parts about axis 206. Other shapes, such as conical, would also allow for relative rotation and/or multiple mounting positions. The multi—part housing of breakout 106 which allows for the relative rotation and/or multiple relative mounting positions relative to longitudinal axis 206, promotes ease of assembly as each part (insert 214, bottom member 212, organizer 216, and top member 210) is added to the assembly. For example, multiple relative orientations about axis 206 by the parts are permitted. Also, early fixation of the insert 214 to the main cable portion 102 promotes ease of assembly, as less parts are loose at any one time. Also, rotating the inspection aperture allows for easier final inspection and placement of the flowable fixation media.

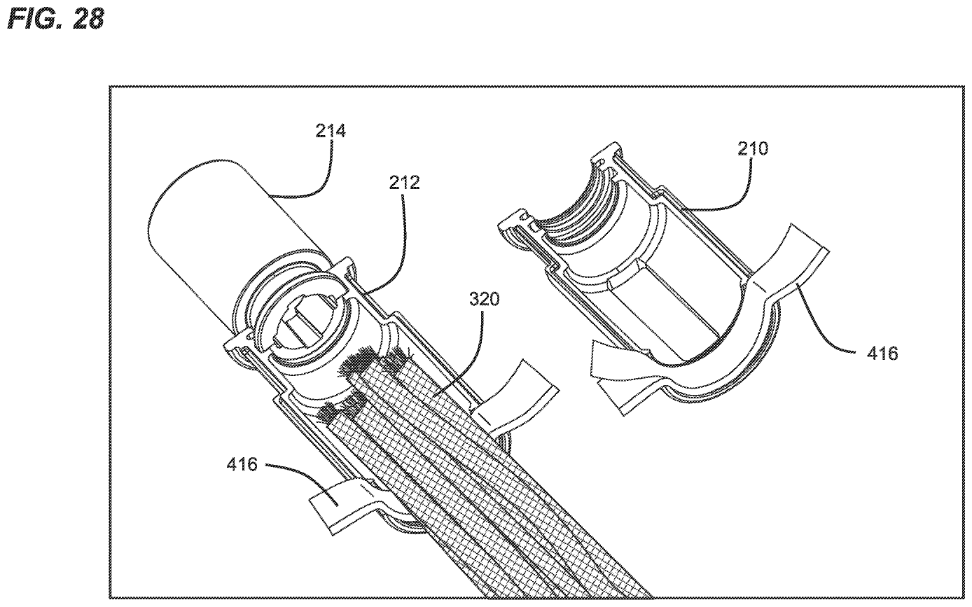

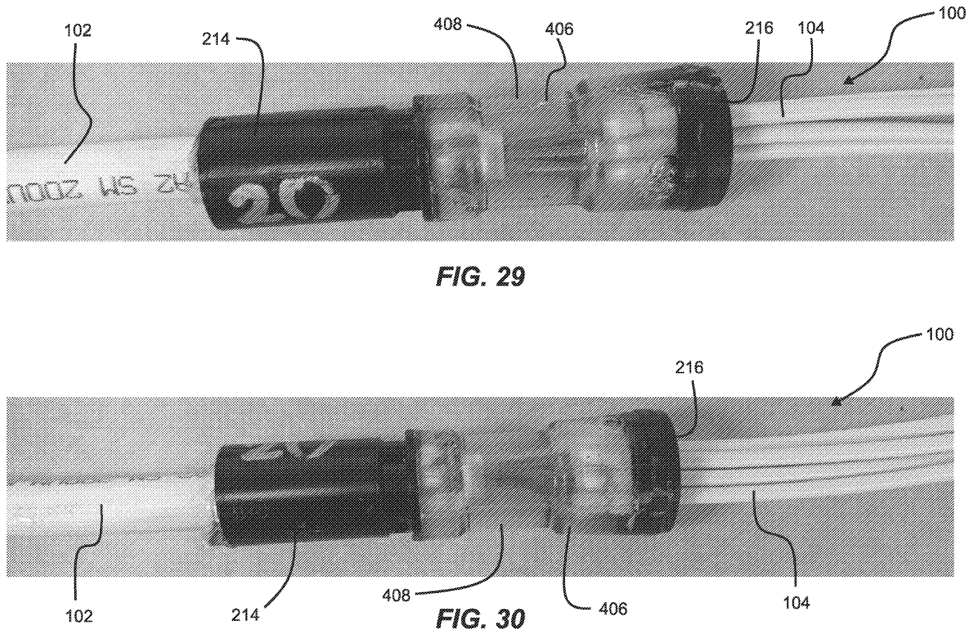

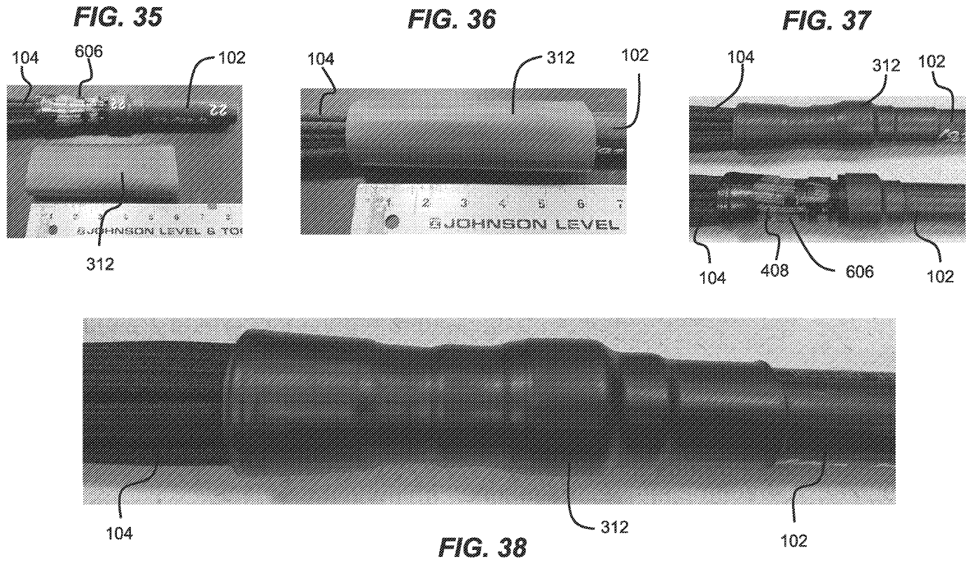

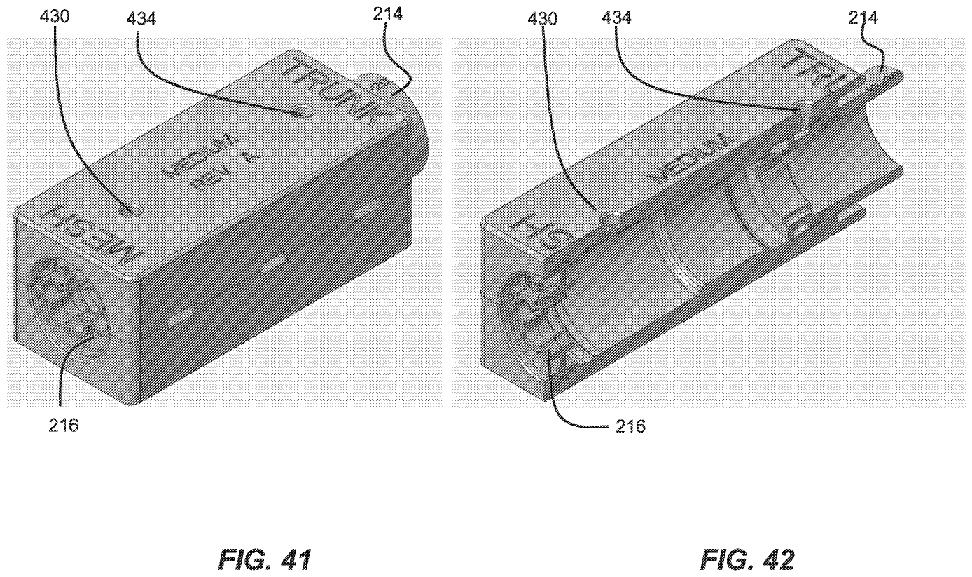

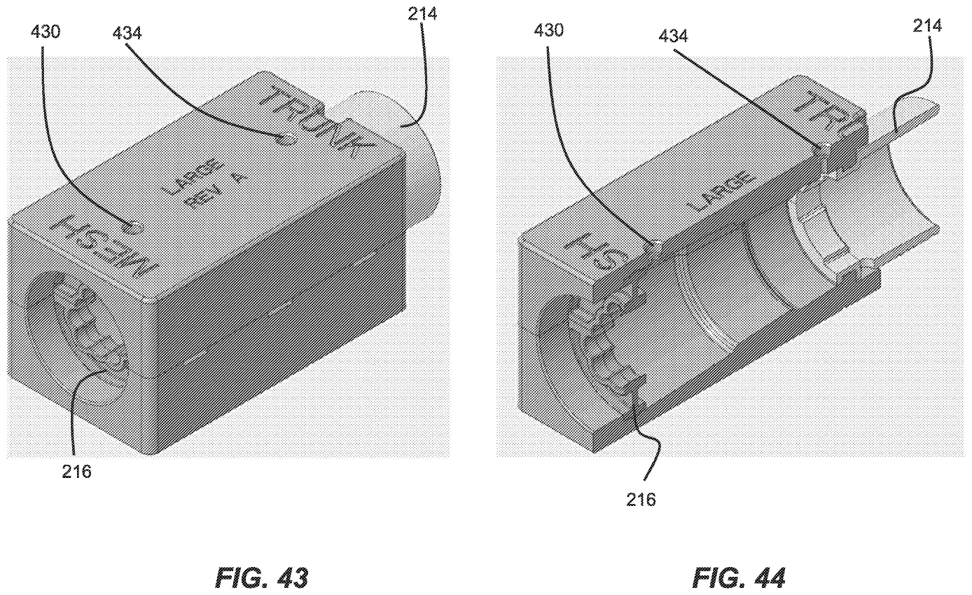

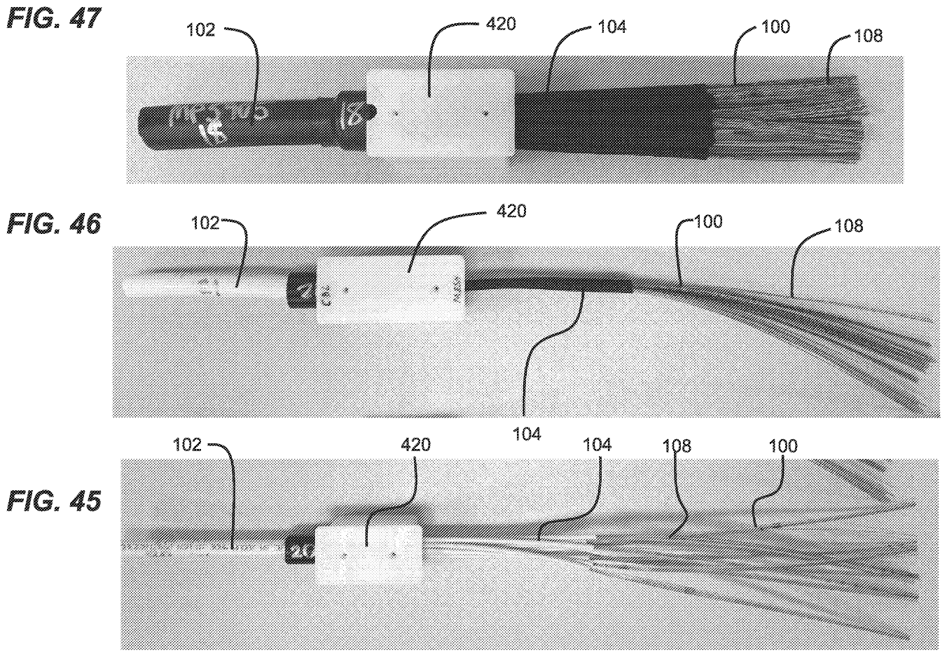

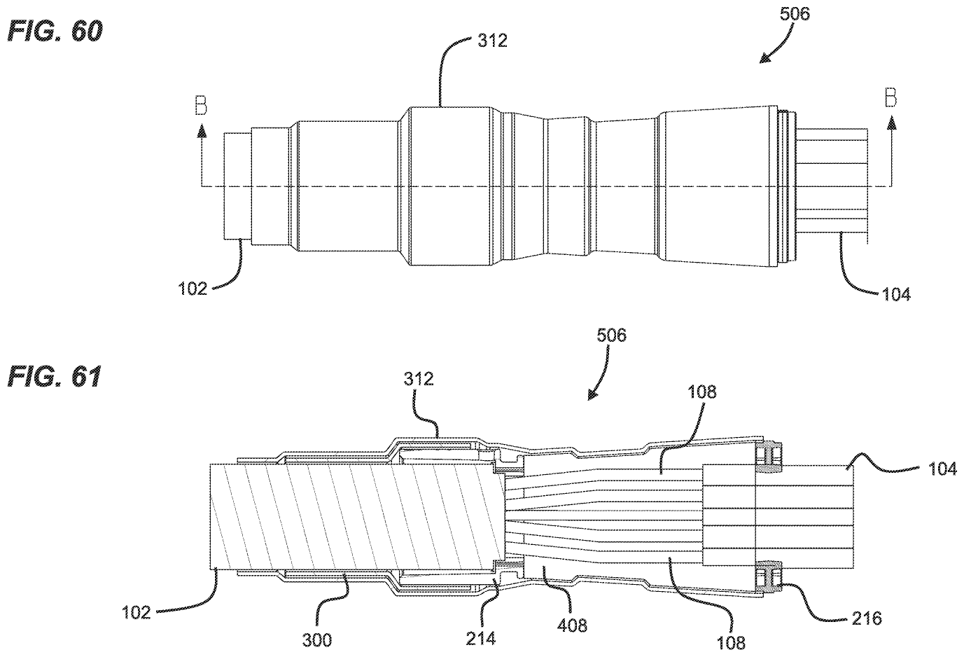

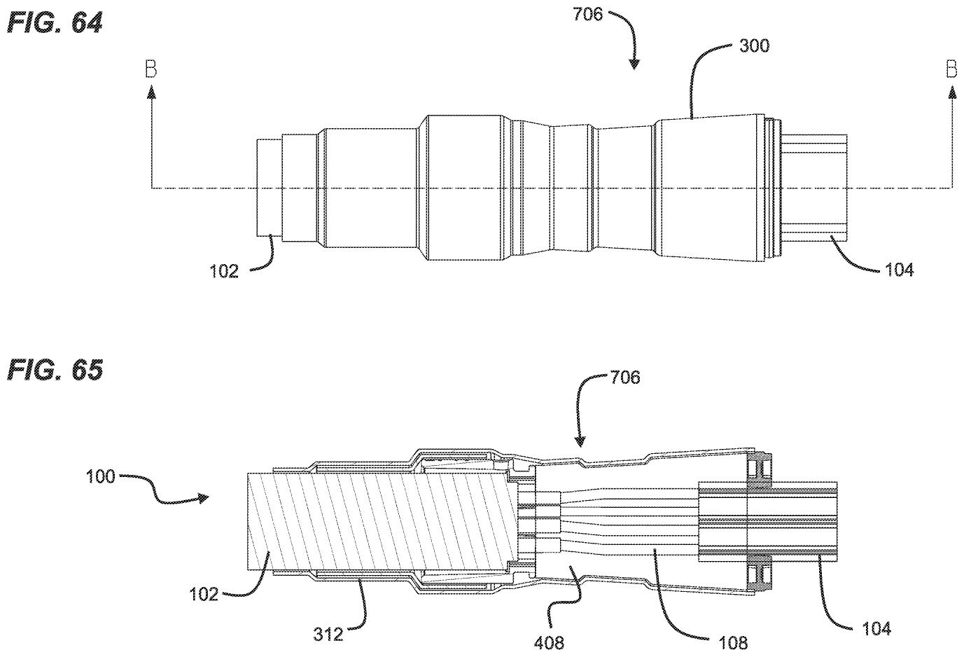

FIGS. 29-65 show alternative main cable breakouts including a molded in place main body extending over the transition from the main cable to the cable subunits, a molded main body extending between an insert and an organizer.

FIGS. 29 and 30 show a first alternative main cable breakout 406, including 144 fibers, and 12 cable subunits 104, including overtubings.

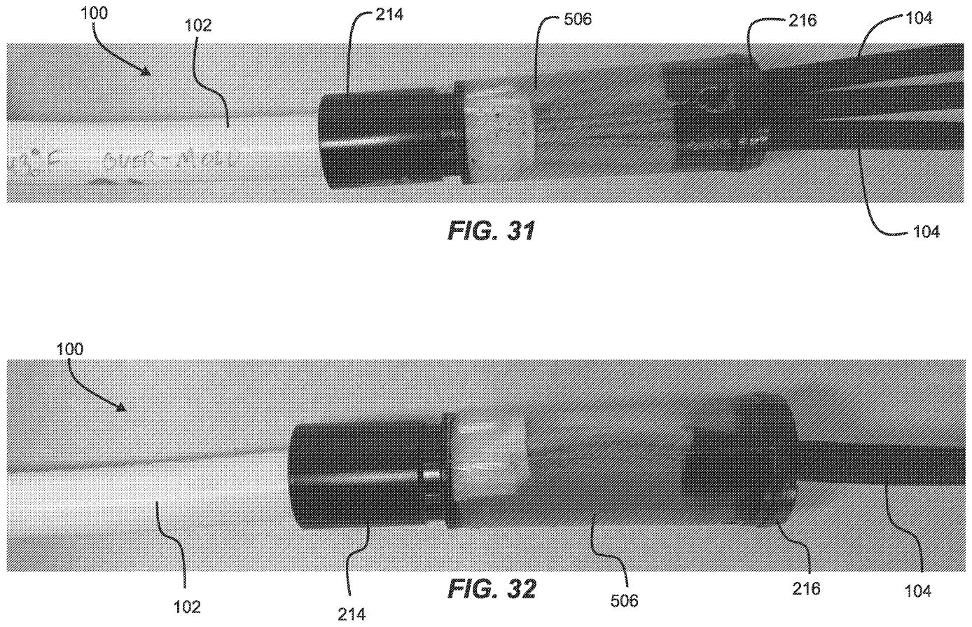

FIGS. 31 and 32 show a second alternative main cable breakout 506, including 432 fibers, and 3 cable subunits 104, including mesh sleeves.

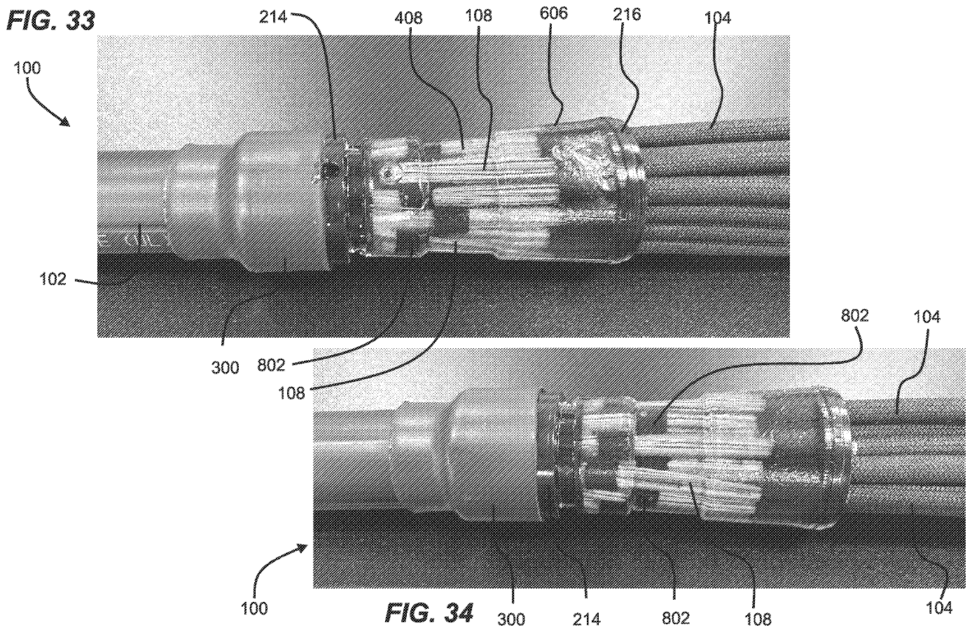

FIGS. 33 and 34 show a third alternative main cable breakout 606, including 2880 fibers, and 20 cable subunits 104, including mesh sleeves. Insert 214 is shown affixed to main cable portion 102 by a heat shrink 300. Heat shrink 300 may assist with preventing leaking of the molding material to make the main body of the cable breakout. Spacers 802 are shown to help promote flow of the molding material within cable breakout 606 during the molding process. Each spacer 802 is in the form of a band and positioned around a plurality of fibers 108, or around a bundle of fibers made up of one or more ribbons, within the cable breakout. Each spacer 802 can be made from a cut length of mesh sleeve placed around the grouping of fibers.

Main cable breakouts 406, 506, 606 include a molded main body 408 made from curable or hardenable material, such as epoxy. Main body 408 is molded around the cable transition between the main cable portion 102 and the cable subunits 104. As will be described below, a mold is positioned over the transition area for molding the main body 408. Also positioned within mold at the time of molding the main body 408 is one insert 214 as described above, and one endcap or organizer 216 as described above.

Main cable breakouts 406, 506, 606 are similar to breakout 106, with the epoxy body portion extending around the fibers 108 that extend from the main cable 102 to the cable subunits 104, between insert 214 and organizer 216. Main cable breakouts 406, 506, 606 lack permanent top and bottom members 210, 212. Instead, a removable mold forms the main molded body over the internal fibers of the breakout.

As shown in FIGS. 35-38, the heat shrink 312 can be added over main cable breakout 606, as well as main cable breakouts 406, 506.

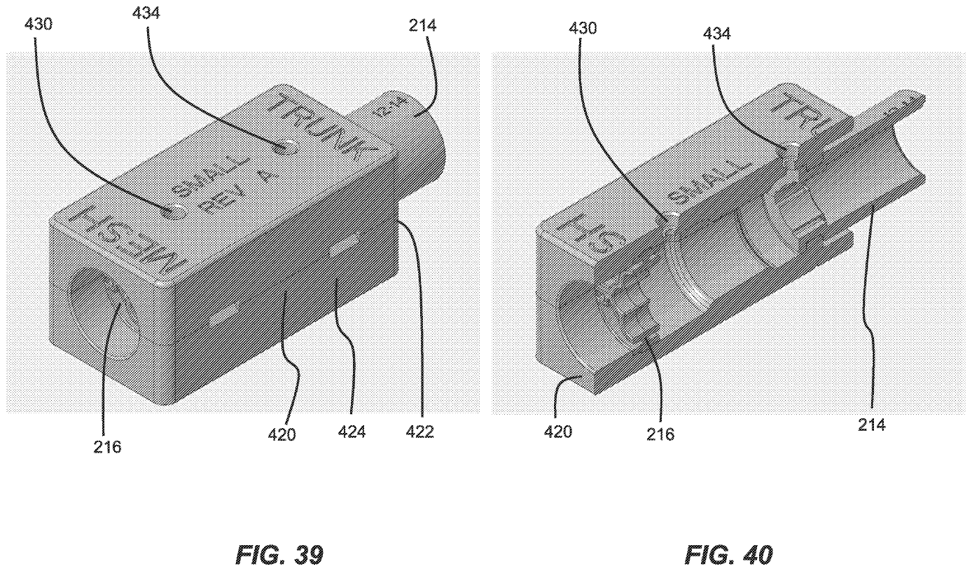

Referring now to FIGS. 39-50, molds are shown for formation of main cable breakouts 406, 506, 606. Mold 420 includes an upper mold portion 422 and a lower mold portion 424. Mold 420 includes a fill hole 430 for the moldable material to enter the mold interior, and an air vent hole 434. As shown in FIG. 40, mold 420 holds insert 214 and organizer 216 during the molding process. Main breakout body 408 is formed in place over the main cable transition area from a cured or hardened moldable fixation media, such as epoxy.

Referring now to FIGS. 48-50, the upper mold portion 422 is removed from the lower molded portion 424 showing the final molded main body 408.

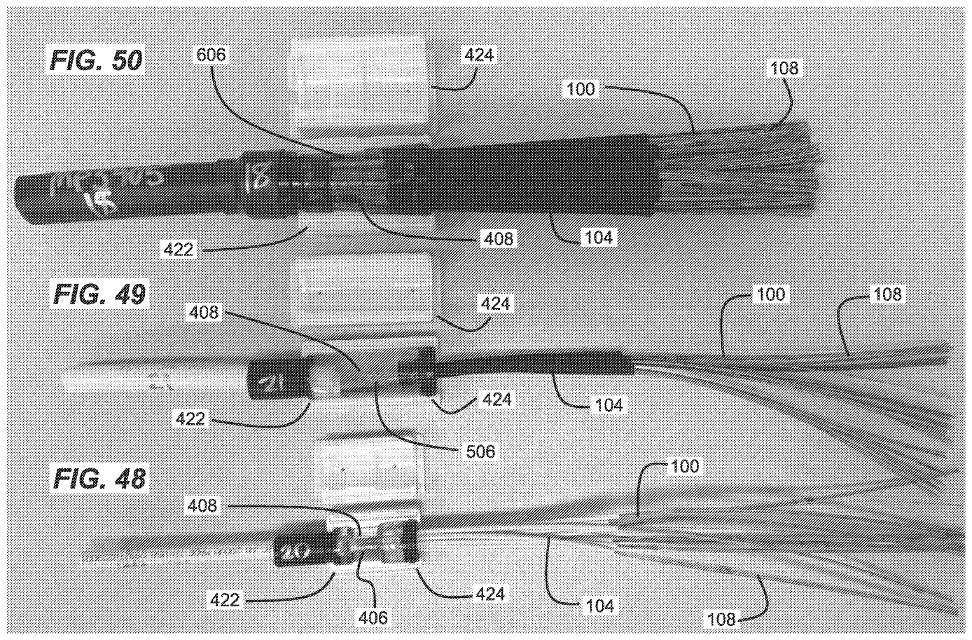

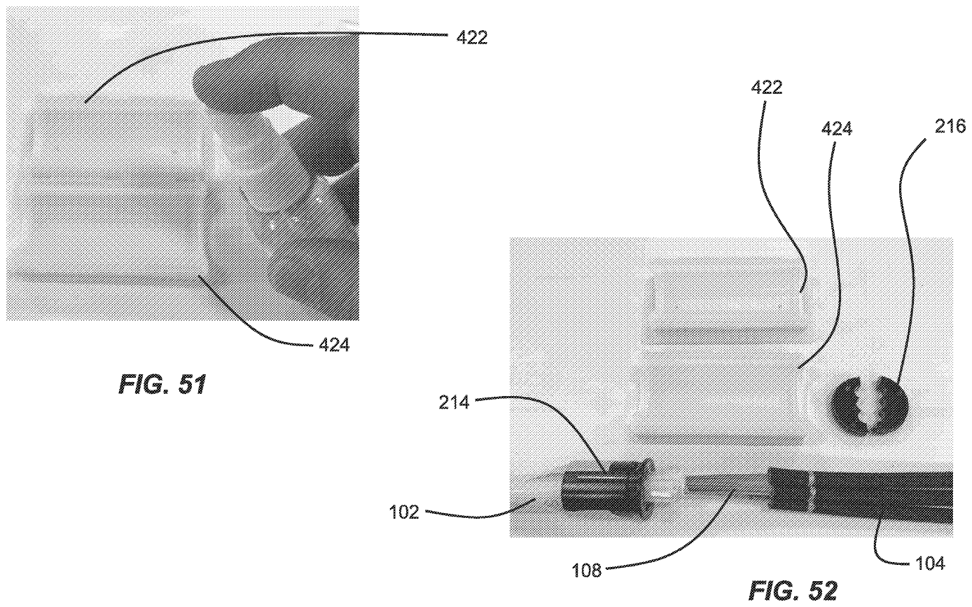

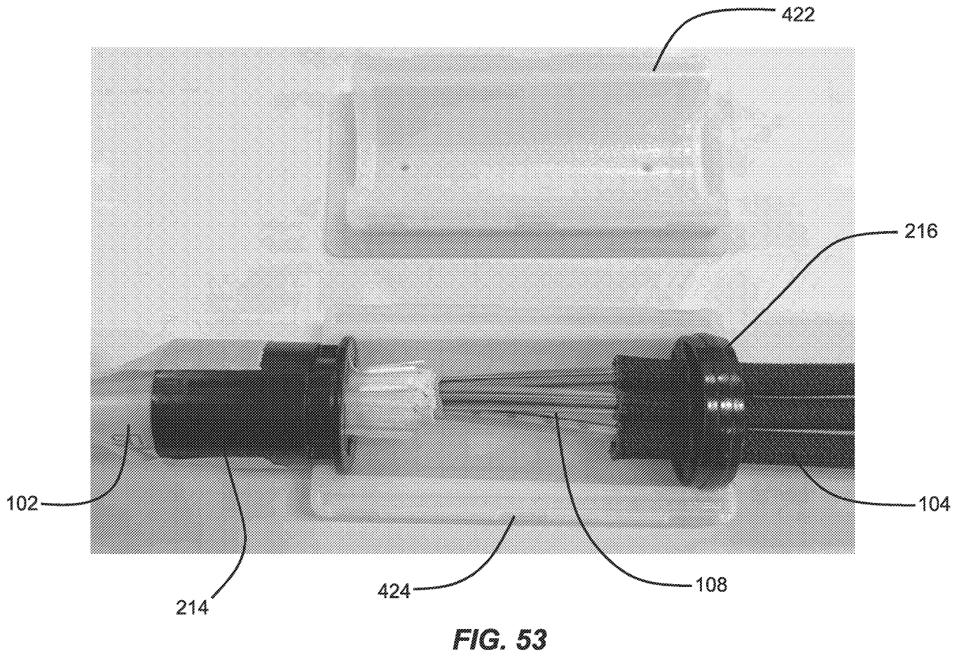

Referring now to FIGS. 51-53, steps in the molding process are shown. In FIG. 51, a release agent is sprayed inside of the mold portions 422, 424. Referring now to FIG. 52, the cable 102, the insert 214, and the organizer 216 are assembled in place in the mold as shown in FIG. 53. While the cable 102 is positioned in the lower mold portion 424 as shown in FIG. 53, the cable, and/or the insert 214, and/or the organizer 216 can be rotated relative to a lower mold portion 424. Rotation is also possible of the same elements once the upper mold portion 424 is added. Rotation of the parts allows for the cable and the mold to be properly positioned with the fill hole(s) in the correct location for filling with a syringe or other tool, in a low or no pressure molding operation.

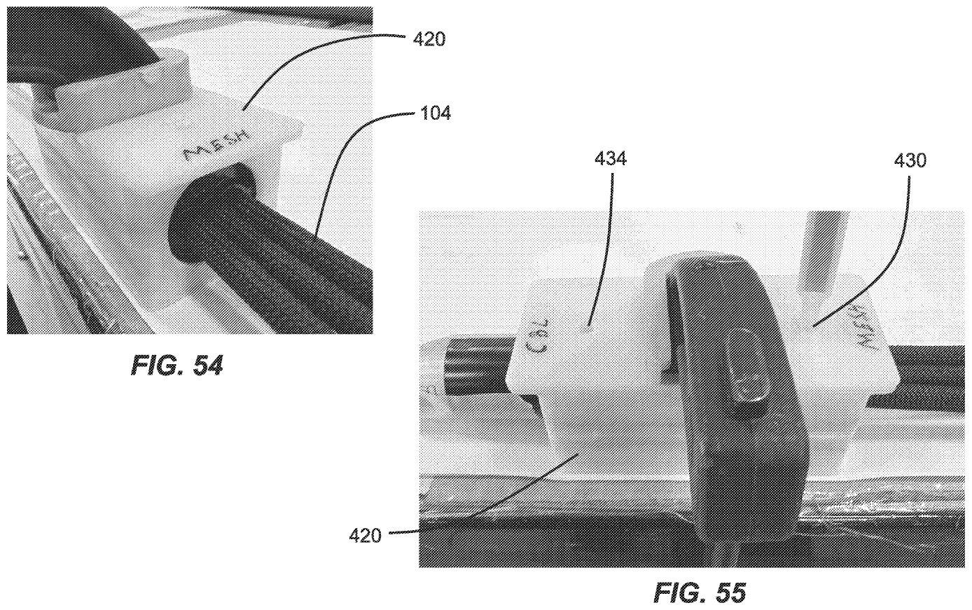

The mold 420 is shown clamped shut in FIGS. 54 and 55. FIG. 55 shows the mold being filled through the fill hole 430 with epoxy from a syringe 440. The epoxy flows around the internal elements within the mold. Air escapes through vent hole 434 or through relief areas 702 as will be described below.

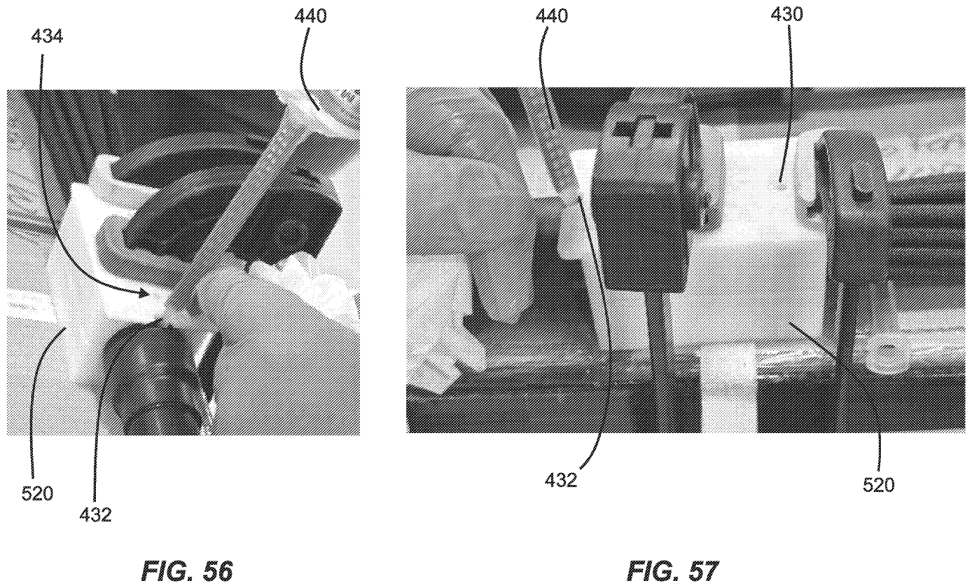

Referring now to FIGS. 56 and 57, an additional fill hole 432 is provided in an alternative mold 520 to provide additional epoxy adjacent to insert 214.

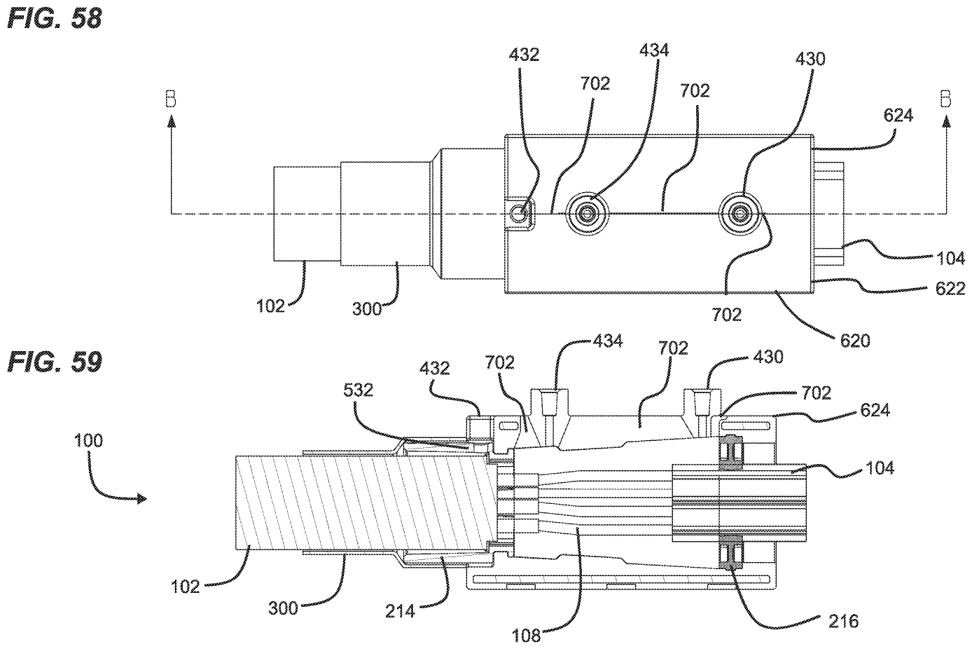

Referring now to FIGS. 58-61, the 2880 fiber breakout 606 and a further mold 620 are shown in further detail. As shown in FIGS. 59 and 61, insert 214 includes an epoxy opening 532 which is aligned with additional fill hole 432. Epoxy opening 532 allows for epoxy to flow inside of insert 214 adjacent to the jacket of the main cable. Mold 620 is a mold with two side portions 622, 624 instead of upper and lower mold portions as in molds 420, 520.

Referring now to FIG. 59, mold portion 624 includes relief areas 702 to help promote removal of air bubbles from within the uncured/non-hardened epoxy within mold 620. Relief areas 702 are slightly gapped areas between mold portions 622, 624 in select areas. Relief areas 702 may produce thin flash portions of molded material, which is easily removed with a cutting tool.

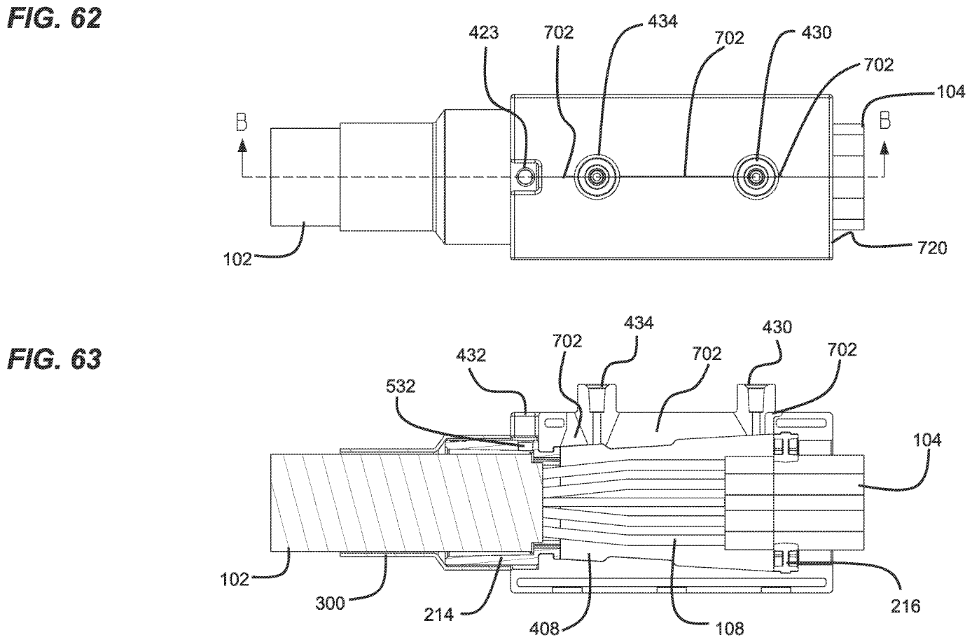

Referring now to FIGS. 62-65, a 3456 fiber breakout 706 and a further mold 720 are shown in further detail.

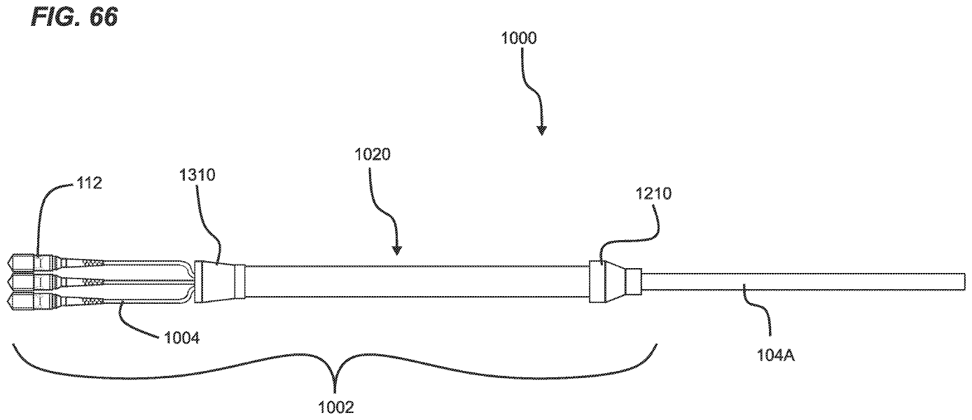

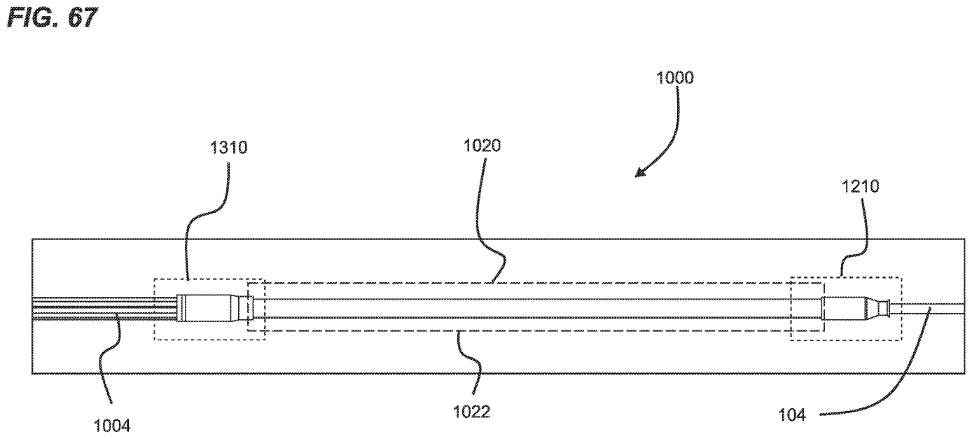

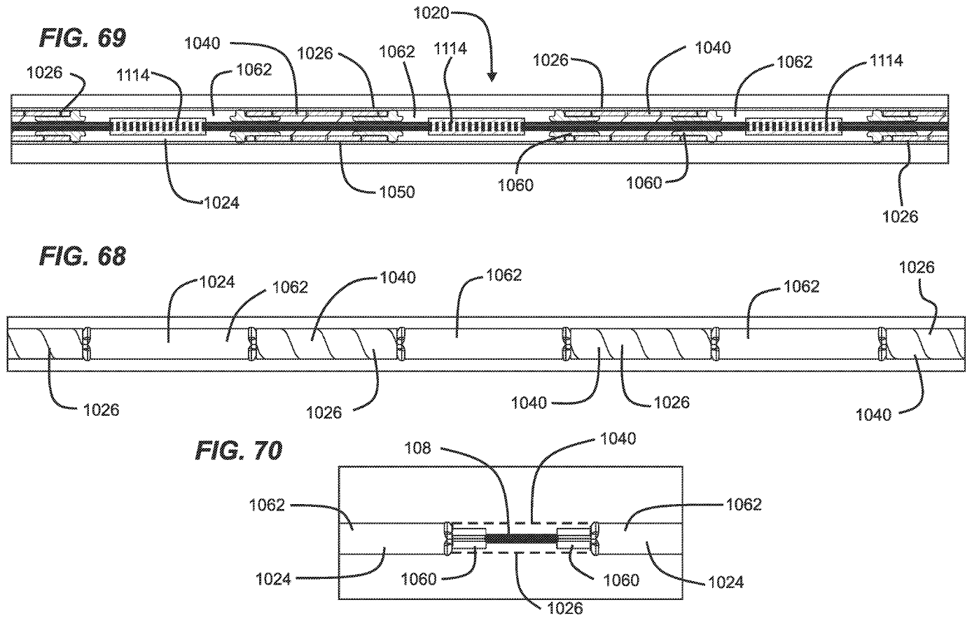

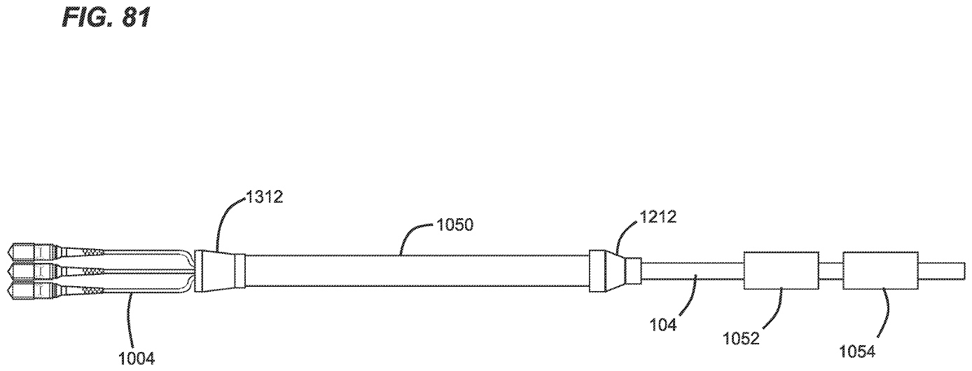

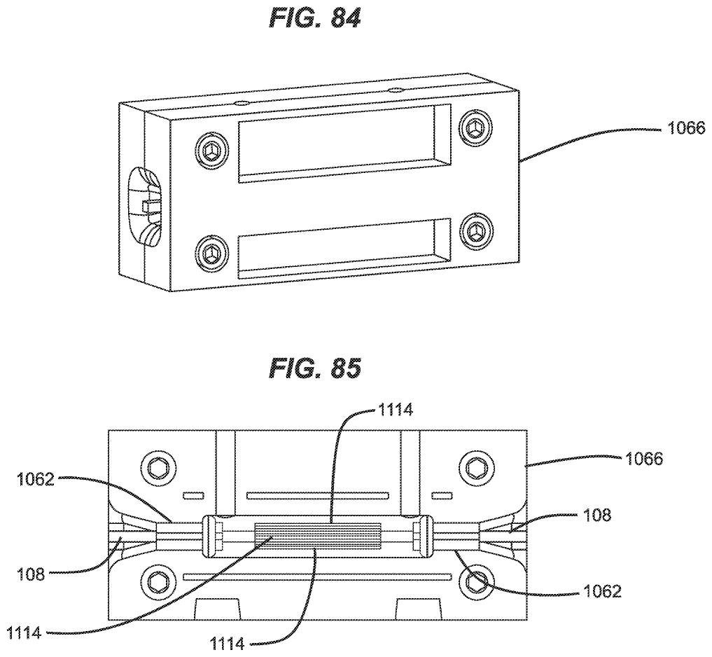

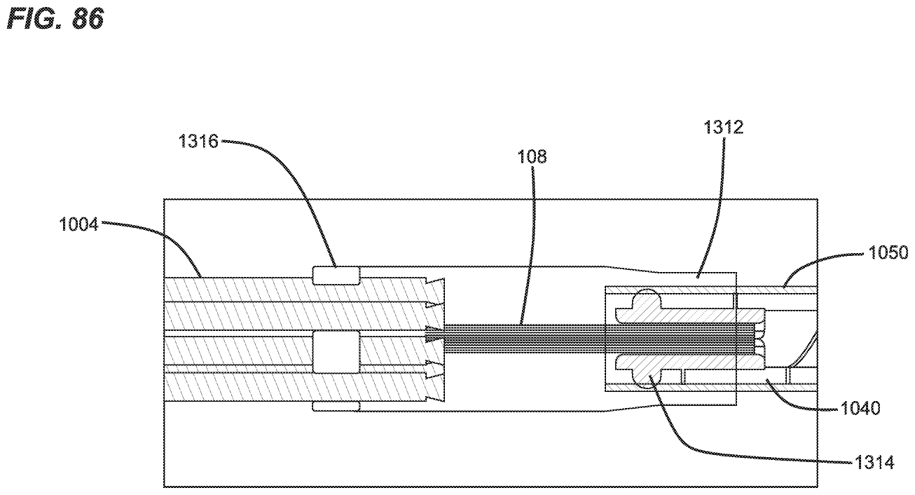

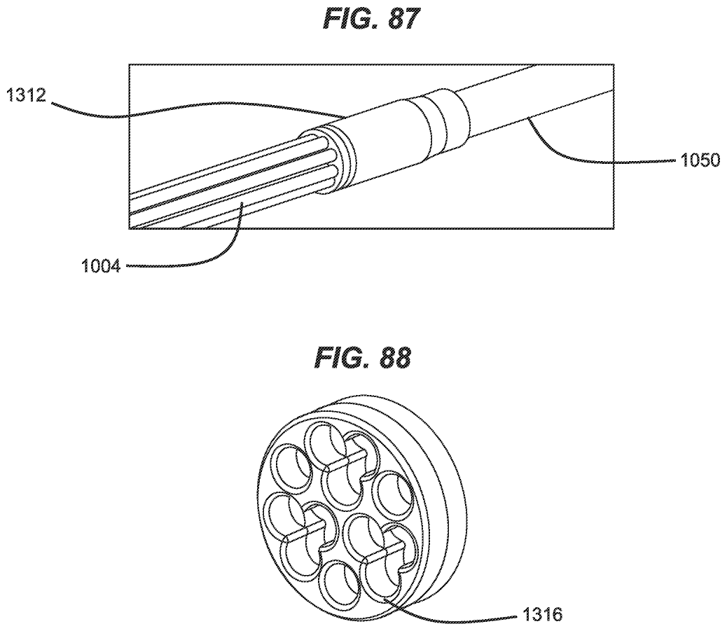

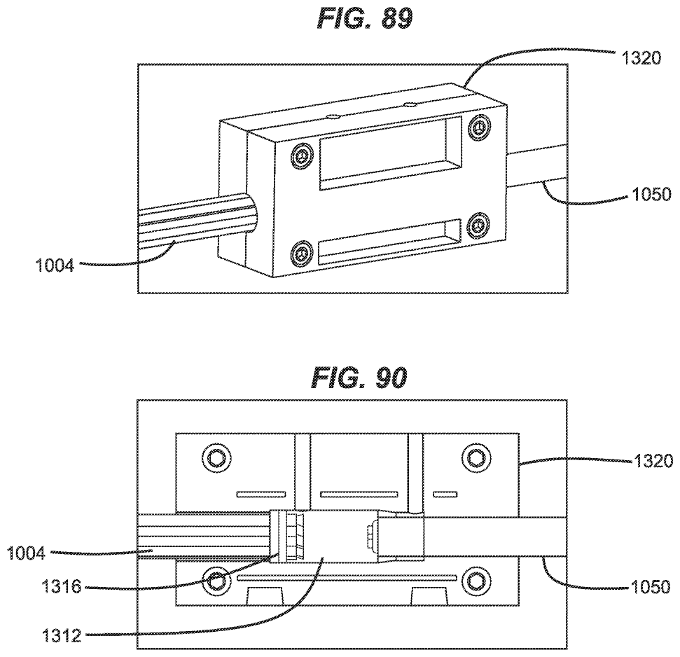

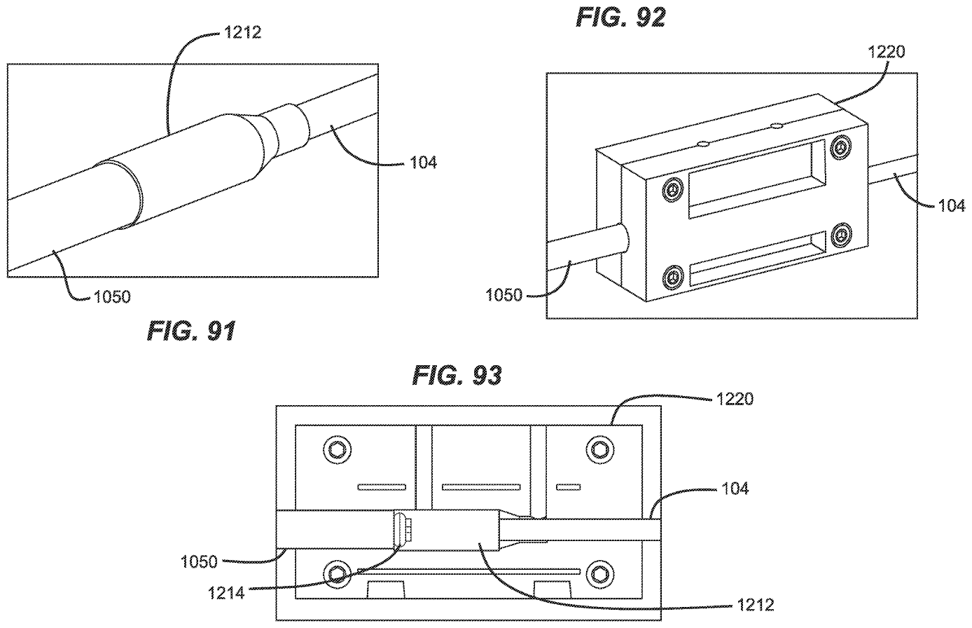

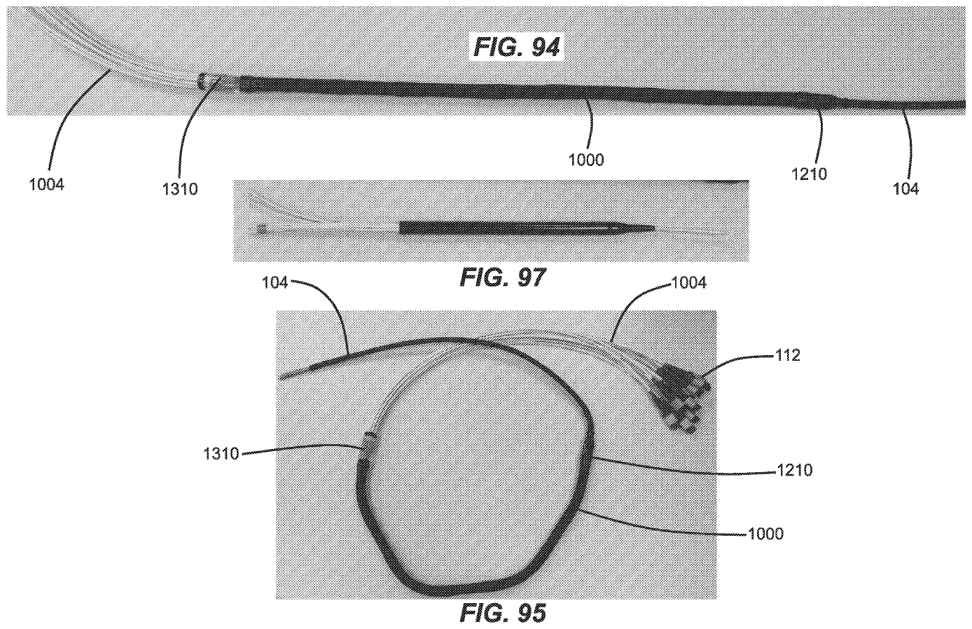

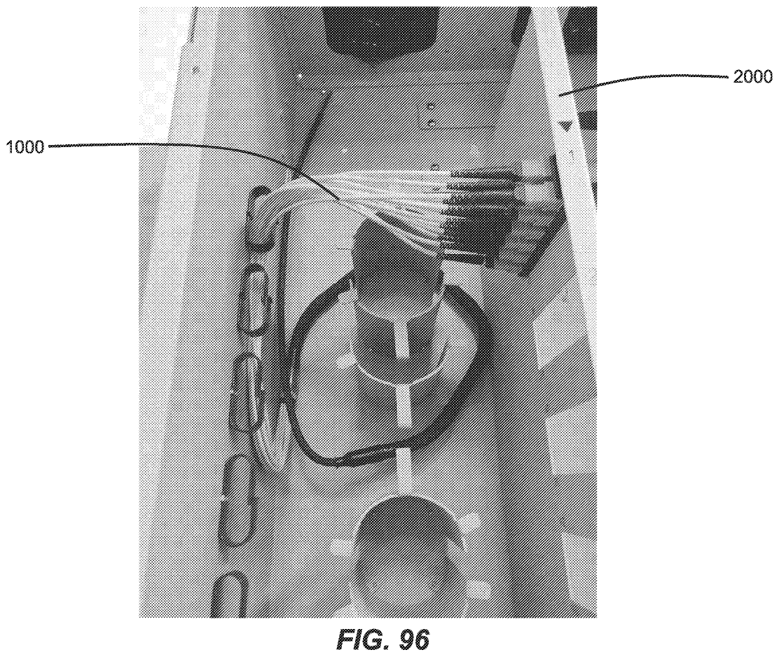

In some examples of cable assembly 100, the optical connectors 112 can be directly terminated to the unterminated ends of the optical fibers. In other examples, the optical connectors 112 can be spliced on to the unterminated ends of the optical fibers. A cable assembly 1000 shown in FIGS. 66-96 includes a splice breakout or fanout assembly 1002 with spliced on cable breakouts 1004. Cable breakouts 1004 are upjacketed shorter lengths of fiber cable terminated with a connector 112, and spliced to the rest of the cable, the trunk cable then being provided with broken out subunits 1004. Cable breakouts 1004 include an upjacketed protective tubing 1006. A protective assembly 1020 protects the splices 1010, such as when the cable assembly 1000 is being pulled through conduit applications leading to telecom central offices, data centers or other data communication or connection sites. The protective assembly 1020 protects the splices 1010 when the cable assembly is installed in and around equipment. Cable assembly 1000 is capable of use like cable assembly 100, where the various outer layers described above or other layers are placed over the cable assembly for trunk cable installation.

Example cable assembly 1000 includes multi-fiber cables, multi-fiber connectors 112 (MPO's) and ribbon splices 1010. In one example, the ribbon splices 1010 include a laminate splice protector 1114. See FIGS. 72-74. In some examples, laminate splice protectors of the types shown in U.S. Pat. No. 11,681,102 and US20220291453, the disclosures of which are hereby incorporated by reference, may be used.

Cable assembly 1000 includes epoxy molded breakout (fanout) housings 1210, 1310 with subunits. The cable assembly 1000 can be configured to various breakout fiber count sizes by using appropriately sized subunit jacketing and epoxy molded fanout housings. In one example, the subunit jacketing includes braided sleeving.

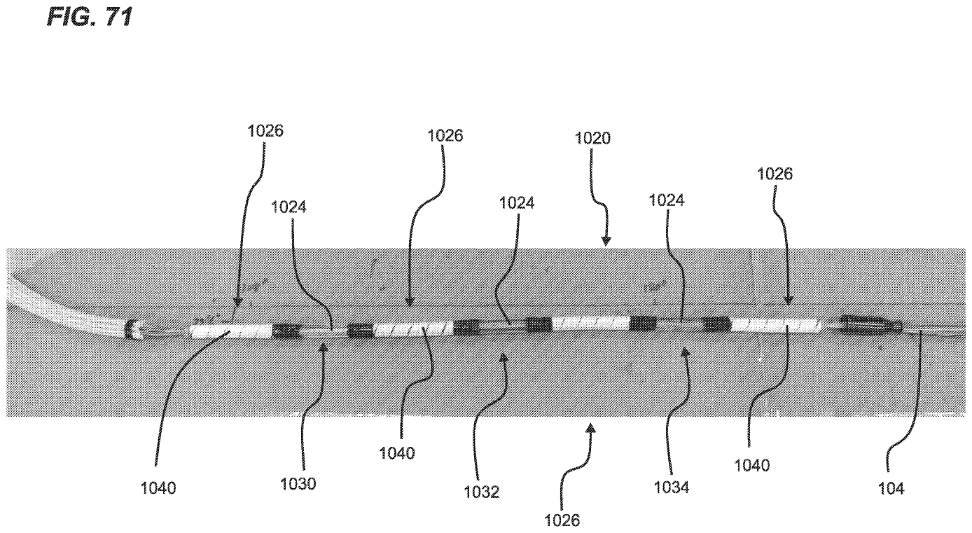

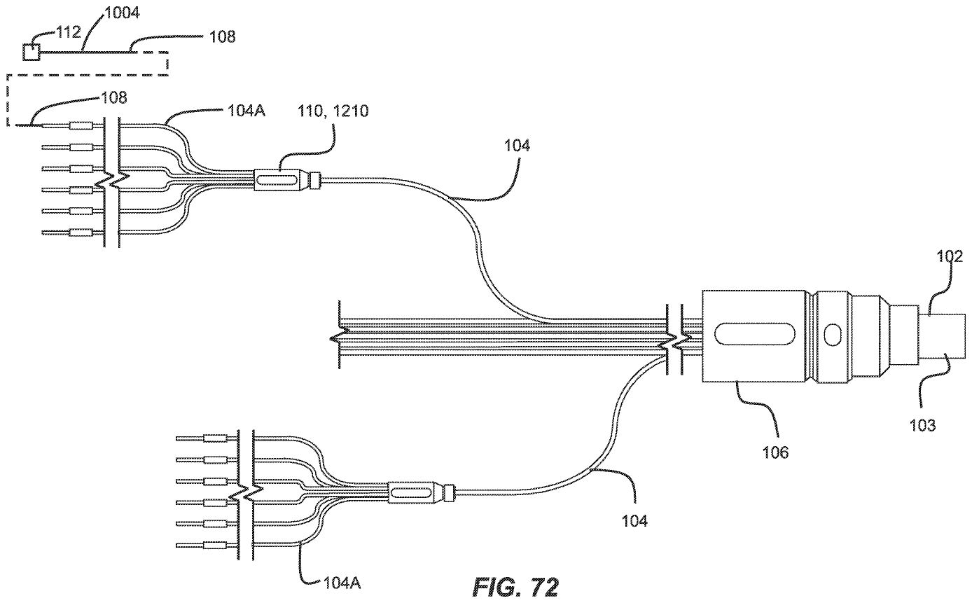

The splice breakout 1002 is multi-ribbon breakout and includes the splices 1010 for each ribbon being located in specific locations 1030, 1032, 1034 that allow sufficient ribbon length for reaching splice equipment and allow for splice reworks if necessary. To create an effective preterminated multi-ribbon fiber trunk assembly with multi-ribbon splice breakouts, the splices need to withstand the handling of trunk cable installation through conduit or other cable routing locations, and be flexible enough to be installed in such locations that often have sweeping bends up to 90 degrees going into the connection site including equipment 2000. See FIGS. 94-96. FIG. 97 shows a prior art splice assembly that is not cable of bending like the cable assembly 1000. The cable assembly 1000 with the multi-ribbon breakout 1002 includes a conduit portion 1022, and multiple encapsulated splice locations 1024 axially spaced within the conduit portion. At least one non-encapsulated region 1026 is positioned within the conduit between the encapsulated splice locations. The non-encapsulated region 1026 is more flexible than the encapsulated splice locations 1024. See FIGS. 70 and 71. A non-encapsulated region 1026 can also be provided after the first splice location 1030, and/or after the last splice location 1034 is the example embodiment.

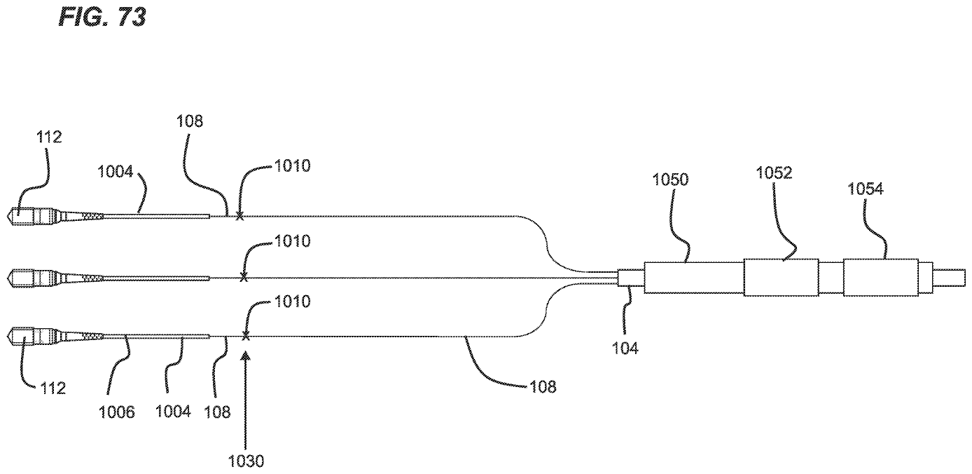

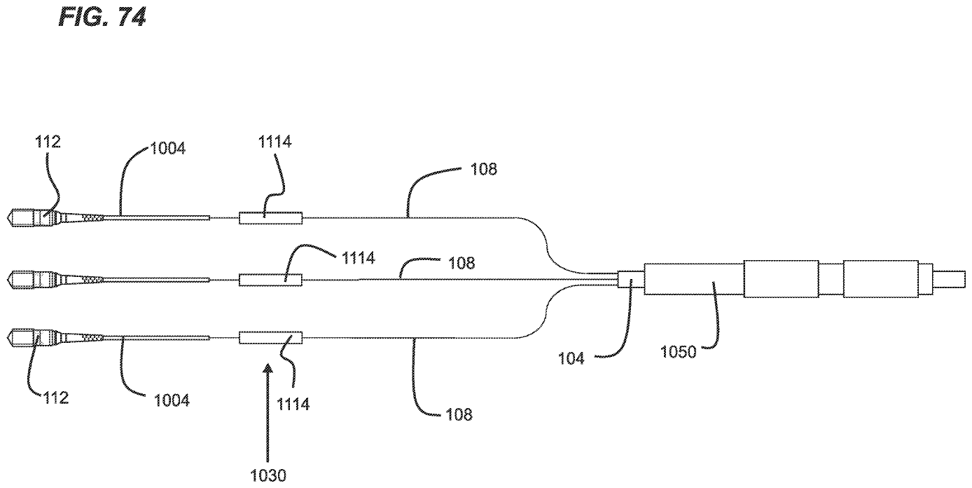

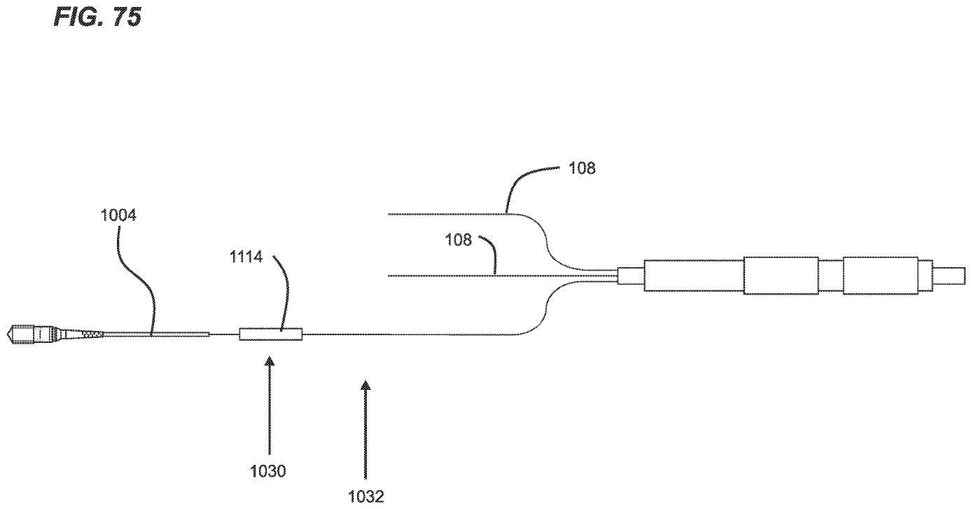

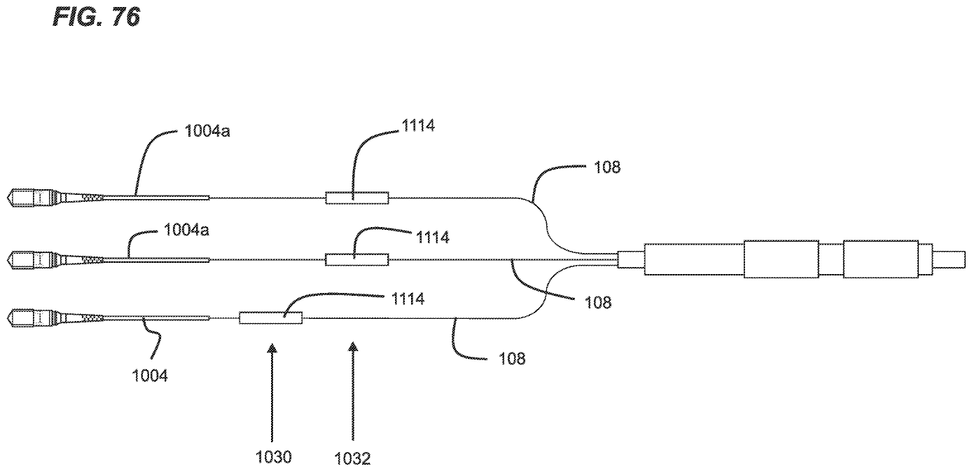

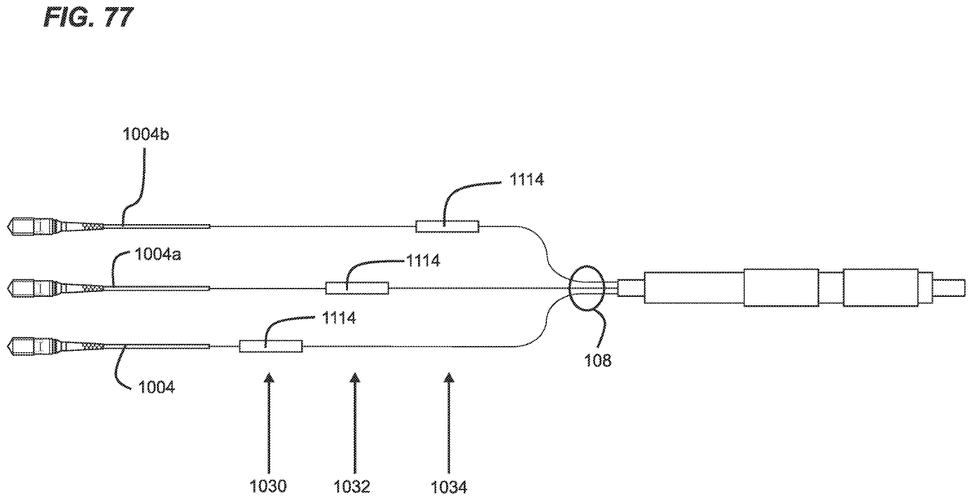

In order to accomplish these recommended breakout requirements, the flexible multi-ribbon breakout includes a predefined splicing length (generally 12 inches to 18 inches) with predefined splicing locations 1030, 1032, 1034 (generally 2 to 4 locations) that are spaced apart to provide a flexible ribbon gap 1026 between the splice locations. The first defined location 1030 is located nearest the cable breakout splice end. It is possible all splices for a multi-ribbon breakout could fall within this same location if splicing of each individual ribbon results in an acceptably performing splice. See FIGS. 73 and 74. However, if one or multiple splices fail, then the ribbon for that failed splice must be cut back to a second defined splice location 1032, and the splice attempt would be retried with longer cable breakouts 1004a. See FIGS. 75 and 76 where two first splices have failed. If any of those fail again, the splice location would be cut back again to a third defined splice location 1034 and the splice attempt would be repeated once again. See FIG. 77 where one of the second splices has failed, and a new splice is tried with a still longer cable breakout 1004b. Additional splice locations may be predefined.

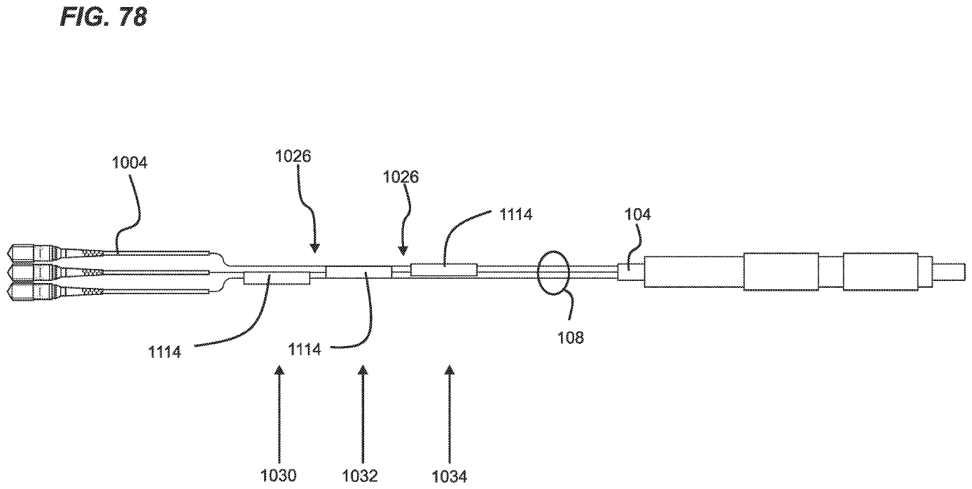

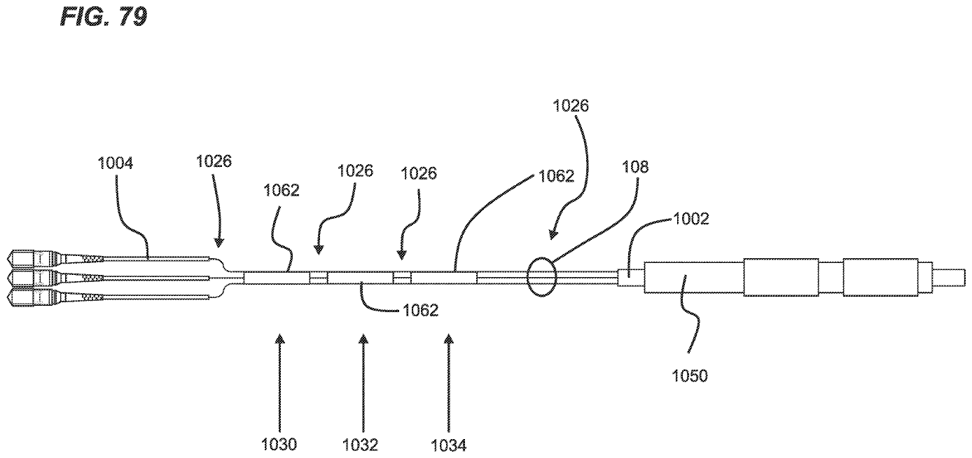

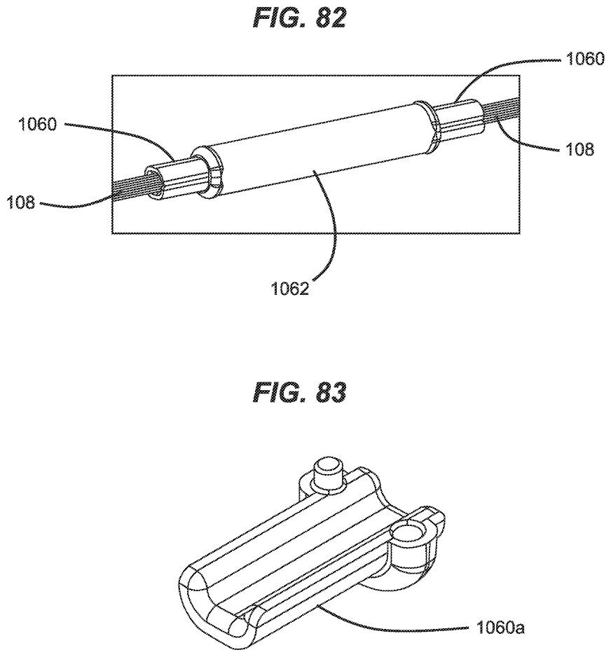

The number of defined splice locations is determined to be sufficient to have splice success for the ribbon to be spliced within the predefined splicing length. Once all of the ribbons 108 in a breakout group are successfully spliced and installed with a laminate protector 1114, the ribbons 108 are then laid out in groups (see FIG. 78) so that the laminate splice protectors and ribbons within each predefined splicing location can be epoxy overmold 1062 (see FIG. 79). Epoxy overmolding of the laminated splice locations 1030, 1032, 1034 is done to each splice location to make them ruggedized for installation handling. Predefined splice locations only need to be overmolded if they have a spliced ribbon. The epoxy overmolding process utilizes ribbon organizer components, such as end plugs 1060 and an epoxy body 1062 molded in place by mold 1066, that fit on each side of a laminate protector 1114 and around the stacked up ribbons in the breakout group. Plugs 1060 can be made as two identical parts 1060a, and assembled around the ribbons 108. The purpose of the ribbon organizing components is to keep the ribbons in stacked groups, provide a sealing diameter to the epoxy overmold fixture and prevent epoxy from leaking onto the ribbons adjacent to the epoxy overmold laminate splices so those ribbons can remain flexible. See FIGS. 82-85 for the splice overmolding assembly and molding tools.

After all laminated spliced locations are overmolded with end plugs 1060 and an epoxy body 1062, the remaining exposed flexible ribbon bundles on each side of the epoxy overmolded splices are covered with a flexible protective tubing 1040 to provide protection from crush and excessive buckling of the exposed ribbons. In one example, the protective tubing 1040 can be a spiral wrap. The spiral wrap is cut to the needed length and added after the epoxy overmolding is complete by rotating the spiral wrap over the ribbon bundles until the ribbon bundles are contained within the spiral wrap. The spiral wrap 1040 will seat on each ribbon organizer component of the epoxy overmold splices with its diameter preferably being no larger than the outer diameter of epoxy overmolded splices. See FIGS. 66-71. There is also a benefit to using spiral wrap when two ribbons are terminated to one location as would occur on connectors like the MPO24. In this case there may be a slight difference between the two ribbons lengths. The use of spiral wrap would allow excess length of the longest ribbon to buckle inside of the spiral wrap but remain protected.

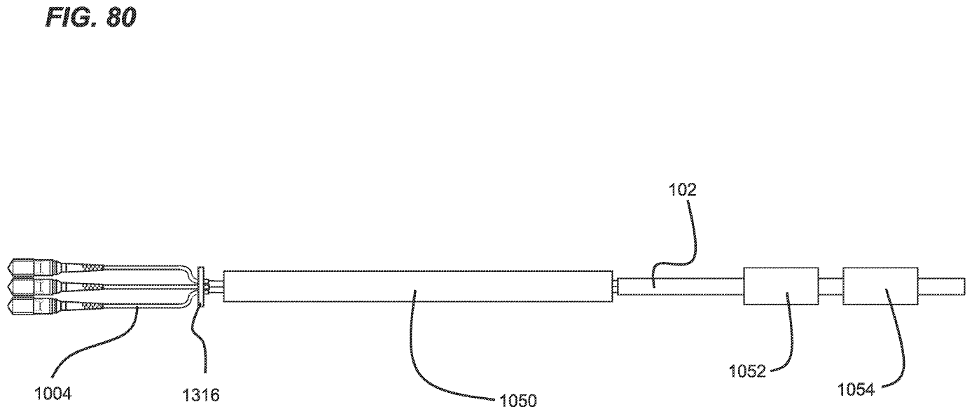

The next step after the placement of spiral wrap 1040 is the installation of braided sleeving 1050 over the predefined splicing length that is now protected with epoxy overmolded laminated splices and spiral wrap. The braided sleeving for this step is preinstalled over the smaller braided sleeving subunit prior to the ribbon splicing. This braided sleeving is cut long enough to cover the full predefined length. It is slid forward to completely cover the entire predefined splicing length and is secured on each end to take up any tensile loads applied to the ribbon breakout. Securing the braiding sleeving that is slid over the predefined splicing length is done by using similar epoxy overmolding housings 1212, 1312 with end caps or organizers 1214, 1314, 1316, formed by molds 1220, 1320 as done for the laminated splice groups at the predefined splice locations except now it is done on each end of the braided sleeving 1050. Heat shrink tubings 1052, 1054 can be added. See FIGS. 80, 81, and 86-93 for the fanout overmolding assembly, the rear overmolding assembly, and molding tooling.

Customized organizer components may be needed on each end of the braided sleeving to provide epoxy seal locations for the epoxy overmolding fixtures that will be used on each end.

There are a number of benefits of cable assembly 1000 with preterminated flexible splice multi-ribbon trunk breakouts over direct terminated breakouts as in cable assembly 100. The termination process for ribbon connectors (typically MPO connectors come in various fiber counts: 4f, 8f, 12f, 16f, 24f) can be performed on a dedicated line (or multiple lines) that is optimized for stub end (pigtail) multifiber connector assemblies ensuring connectors have the highest possible performance. Preterminated flexible splice multi-ribbon trunk breakouts can be built much faster than direct terminated breakouts. This can save days to weeks on assembly builds depending on cable fiber count size. Although splice on is best done in a controlled factory, this solution could easily be adaptable to field terminations.

What is claimed is:

1. A cable pulling assembly comprising:
a cable assembly extending along a length, the cable assembly including a main cable including a jacket surrounding a plurality of cable subunits, the main cable having an end at which the jacket is terminated, the cable subunits extending past the end of the main cable, each cable subunit including a plurality of connectorized ends each terminated with a respective fiber optic connector;
a cable breakout at the end of the main cable, wherein the cable breakout includes:
a top member, a bottom member, an organizer, and an insert, the top member including an inspection aperture, the organizer and the insert each having a portion with a circular or cylindrical outer perimeter, the top member and the bottom member holding the organizer and the insert about the portions with the circular or cylindrical outer perimeters to define an internal space for holding a transition portion of the main cable and the cable subunits;
a plurality of bags, each bag being disposed over the plurality of connectorized ends of a respective one of the cable subunits, each bag defining a plurality of chambers, each chamber receiving one of the fiber optic connectors of the respective cable subunit;
a plastic sleeve positioned over the cable assembly so that the plastic sleeve extends over a portion of the main cable and over the connectorized ends of the cable subunits;
a crush-resistant arrangement positioned over the plastic sleeve; and
a mesh sleeve positioned over the crush-resistant arrangement.

2. The cable pulling assembly of claim 1, wherein the cable subunits have different lengths to stagger the fiber optic connector terminating the connectorized ends.

3. The cable pulling assembly of claim 1 or claim 2, wherein the chambers of one of the bags have a common length.

4. The cable pulling assembly of any of claims 1-3, wherein the chambers are arranged in a row along a width of the bag.

5. The cable pulling assembly of any of claims 1-4, wherein the crush-resistant arrangement includes a plurality of segmented tubes.

6. The cable pulling assembly of any of claims 1-4, wherein the crush-resistant arrangement includes a continuous tube.

7. The cable pulling assembly of any of claims 1-6, wherein the bags are staggered from each other along the length of the cable assembly.

8. A cable breakout for use at the end of the main cable, comprising:
a top member, a bottom member, an organizer, and an insert, the top member including an inspection aperture, the organizer and the insert each having a portion with a circular or cylindrical outer perimeter, the top member and the bottom member holding the organizer and the insert about the portions with the circular or cylindrical outer perimeters to define an internal space for holding a transition portion of an incoming main cable and outgoing cable subunits.

9. The cable breakout of claim 8, further comprising a main cable including a jacket surrounding a plurality of cable subunits, the main cable having an end at which the jacket is terminated, the cable subunits extending past the end of the main cable, each cable subunit including a connectorized end terminated with a fiber optic connector.

10. The cable breakout of claim 9, further comprising:
a plastic sleeve positioned over the cable assembly so that the plastic sleeve extends over a portion of the main cable and over the connectorized ends of the cable subunits;
a crush resistant layer over the plastic sleeve; and
a mesh sleeve positioned over the crush resistant layer.

11. The cable breakout of claims 8-10, further comprising a cured or hardened fixation media within the cable breakout.

12. The cable breakout of claims 8 and 9, wherein top member and the bottom member are rotatable relative to at least one of the insert and the organizer, and preferably both the insert and the organizer.

13. The cable breakout of claims 8-12, wherein the organizer includes identical halves.

14. The cable breakout of claims 8-13, further comprising a kit of organizers with different apertures for different sizes or counts of subunits.

15. A cable breakout for use at the end of the main cable, comprising:
a top member, a bottom member, an organizer, and an insert, the top member including an inspection aperture, the insert having a portion with a circular or cylindrical outer perimeter, the top member and the bottom member holding the insert about the portion with the circular or cylindrical outer perimeter and holding the organizer to define an internal space for holding a transition portion of an incoming main cable and outgoing cable subunits.

16. The cable breakout of claim 15, wherein the organizer includes foam tape.

17. The cable breakout of claim 15, wherein the organizer has a portion with a circular or cylindrical outer perimeter.

18. A method of assembling a cable assembly comprising:
positioning a cable breakout over a main cable portion of a cable assembly and over a plurality of cable subunits extending outwardly from the main cable portion;
fixing at least a first portion of the cable breakout relative to the main cable portion and the plurality of cable subunits;
rotating at least a second portion of the cable breakout relative to the main cable portion and the plurality of cable subunits while the first portion is fixed; and
filling the cable breakout with a curable or hardenable fixation media.

19. The method of claim 18, further comprising bundling terminated ends of the cable subunits into plastic bags.

20. The method of claims 18 and 19, further comprising positioning a pulling sleeve positioned over the cable assembly so that the pulling sleeve extends over a portion of the main cable and over the plurality of bags and the connectorized ends of the cable subunits.

21. The method of any of claims 18-20, further comprising installing the cable assembly within a building by routing the cable assembly through a conduit.

22. The method of claim 21, wherein routing the cable assembly through the conduit comprises axially pulling on a mesh sleeve.

23. A cable breakout, comprising:
a main cable having an outer jacket terminating at an end, and outgoing cable subunits extending past the end of the outer jacket, each cable subunit including a connectorized end terminated with a fiber optic connector;
a main breakout body formed in place over the main cable from a cured or hardened fixation media, an organizer at one end of the main breakout body, and an insert at an opposite end of the main breakout body, the organizer and the insert each having a portion with a circular or cylindrical outer perimeter;
wherein the end of the main jacket and a portion of the outgoing cable subunits are positioned within the main breakout body between the insert and the organizer.

24. The cable breakout of claim 23, wherein the cable subunits include mesh sleeves.

25. The cable breakout of claim 23, wherein the cable subunits include overtubings.

26. The cable breakout of claims 23-25, further comprising:
a plastic sleeve positioned over the cable assembly so that the plastic sleeve extends over a portion of the main cable and over the connectorized ends of the cable subunits;
a crush resistant layer over the plastic sleeve; and
a mesh sleeve positioned over the crush resistant layer.

27. The cable breakout of claims 23-26, further comprising spacers, each spacer positioned around a plurality of fibers within the cable breakout.

28. A method of assembling a cable assembly comprising:
positioning an insert around a main cable portion of a cable assembly;
positioning an organizer around a plurality of cable subunits extending outwardly from the main cable portion;
positioning a mold around the insert, the organizer and at least a portion of the main cable portion and a portion the plurality of cable subunits;
rotating the mold relative to the insert, the organizer and at least a portion of the main cable portion and a portion the plurality of cable subunits; and
filling the mold with a curable or hardenable fixation media.

29. The method of claim 28, further comprising bundling terminated ends of the cable subunits into plastic bags.

30. The method of claims 28 and 29, further comprising positioning a pulling sleeve positioned over the cable assembly so that the pulling sleeve extends over a portion of the main cable and over the plurality of bags and the connectorized ends of the cable subunits.

31. The method of any of claims 28-30, further comprising installing the cable assembly within a building by routing the cable assembly through a conduit.

32. The method of claim 31, wherein routing the cable assembly through the conduit comprises axially pulling on a mesh sleeve.

33. The cable pulling assembly of claims 1-7, further comprising:
a conduit;
multifiber ribbons within the conduit; and
multiple encapsulated splice locations axially spaced within the conduit; at least one non-encapsulated region positioned within the conduit between the encapsulated splice locations; the non-encapsulated region being more flexible than the encapsulated splice locations.

34. The cable breakout of claims 8-14, further comprising:
a conduit;
multifiber ribbons within the conduit; and
multiple encapsulated splice locations axially spaced within the conduit; at least one non-encapsulated region positioned within the conduit between the encapsulated splice locations; the non-encapsulated region being more flexible than the encapsulated splice locations.

35. The cable breakout of claims 15-17, further comprising:
a conduit;
multifiber ribbons within the conduit; and
multiple encapsulated splice locations axially spaced within the conduit; at least one non-encapsulated region positioned within the conduit between the encapsulated splice locations; the non-encapsulated region being more flexible than the encapsulated splice locations.

36. The method of claims 18-22, further comprising:
forming multiple axially spaced encapsulated splice locations that splice multifiber ribbons along the cable assembly;
positioning a conduit over the encapsulated splice locations;
positioning at least one non-encapsulated region within the conduit between the encapsulated splice locations;
the non-encapsulated region being more flexible than the encapsulated splice locations.

37. The cable breakout of claims 23-27, further comprising:
a conduit;
multifiber ribbons within the conduit; and
multiple encapsulated splice locations axially spaced within the conduit; at least one non-encapsulated region positioned within the conduit between the encapsulated splice locations; the non-encapsulated region being more flexible than the encapsulated splice locations.

38. The method of claims 28-32, further comprising:
forming multiple axially spaced encapsulated splice locations that splice multifiber ribbons along the cable assembly;
positioning a conduit over the encapsulated splice locations;
positioning at least one non-encapsulated region within the conduit between the encapsulated splice locations;
the non-encapsulated region being more flexible than the encapsulated splice locations.

39. A telecommunications cable assembly, comprising:
a conduit;
multifiber ribbons within the conduit; and
multiple encapsulated splice locations axially spaced within the conduit; at least one non-encapsulated region positioned within the conduit between the encapsulated splice locations; the non-encapsulated region being more flexible than the encapsulated splice locations.

40. The telecommunications cable assembly of claim 39, further comprising a spiral wrap in the non-encapsulated region.

41. The telecommunications cable assembly of claims 39 and 40, wherein each encapsulated splice location includes first and second spaced apart end caps and an epoxy region between the first and second spaced apart end caps.

42. A method of assembling a cable assembly comprising:
forming multiple axially spaced encapsulated splice locations that splice multifiber ribbons along the cable assembly;
positioning a conduit over the encapsulated splice locations;
positioning at least one non-encapsulated region within the conduit between the encapsulated splice locations;
the non-encapsulated region being more flexible than the encapsulated splice locations.

43. The method of claim 42, further comprising positioning a spiral wrap in the non-encapsulated region over the multifiber ribbons.

44. The method of claims 42 and 43, wherein the encapsulated splice locations are formed by molding or hardening a material of splices in the encapsulated splice locations.
